(19) United States
(12) Patent Application Publication
(10) Pub. No.: US 2007/0297519 A1
(43) Pub. Date: Dec. 27, 2007

(54) Audio Spatial Environment Engine

(76) Inventors: Jeffrey Thompson, Bothell, WA (US); Robert Reams, Mill Creek, WA (US); Aaron Warner, Seattle, WA (US)

Correspondence Address: Mr. Christopher John Rourk;Jackson Walker LLP, 901 Main Street, Suite 6000, DALLAS, TX, 75202, US

(21) Appl. No.: 11/666,512

(22) PCT Filed: Oct. 28, 2005
(86) PCT No.: PCT/US05/38961

§ 371 Date: Apr. 27, 2007

Related U.S. Application Data
(63) Continuation-in-part of application No. 10/975,841, filed on Oct. 28, 2004.
(60) Provisional application No. 60/622,922, filed on Oct. 28, 2004.

(51) Int. Cl. G10L 19/02

(52) U.S. Cl. 375/241; 375/E07.029

(57) ABSTRACT

An audio spatial environment engine is provided for converting between different formats of audio data. The audio spatial environment engine (100) allows for flexible conversion between N-channel data and M-channel data and conversion from M-channel data back to N′-channel data, where N, M, and N′ are integers and where N is not necessarily equal to N′. For example, such systems could be used for the transmission or storage of surround sound data across a network or infrastructure designed for stereo sound data. The audio spatial environment engine provides improved and flexible conversions between different spatial environments due to an advanced dynamic down-mixing unit (102) and a high-resolution frequency band up-mixing unit (104). The dynamic down-mixing unit includes an intelligent: analysis and correction loop (108, 110) capable of correcting for spectral, temporal, and spatial inaccuracies common to many down-mixing methods. The up-mixing unit utilizes the extraction and analysis of important inter-channel spatial cues across high-resolution frequency bands to derive the spatial placement of different frequency elements. The down-mixing and up-mixing units, when used individually or as a system, provide improved sound quality and spatial distinction.

### RELATED APPLICATIONS

This application claims priority to U.S. provisional application 60/622,922, filed Oct. 28, 2004, entitled “2-to-N Rendering;” U.S. patent application Ser. No. 10/975,841, filed Oct. 28, 2004, entitled “Audio Spatial Environment Engine;” U.S. patent application Ser. No. 11/261,100 (attorney docket 13646.0014), “Audio Spatial Environment Down-Mixer,” filed herewith; and U.S. patent application Ser. No. 11/262,029 (attorney docket 13646.0012), “Audio Spatial Environment Up-Mixer,” filed herewith, each of which are commonly owned and which are hereby incorporated by reference for all purposes.

### FIELD OF THE INVENTION

The present invention pertains to the field of audio data processing, and more particularly to a system and method for transforming between different formats of audio data.

### BACKGROUND OF THE INVENTION

Systems and methods for processing audio data are known in the art. Most of these systems and methods are used to process audio data for a known audio environment, such as a two-channel stereo environment, a four-channel quadraphonic environment, a five channel surround sound environment (also known as a 5.1 channel environment), or other suitable formats or environments.

One problem posed by the increasing number of formats or environments is that audio data that is processed for optimal audio quality in a first environment is often not able to be readily used in a different audio environment. One example of this problem is the transmission or storage of surround sound data across a network or infrastructure designed for stereo sound data. As the infrastructure for stereo two-channel transmission or storage may not support the additional channels of audio data for a surround sound format, it is difficult or impossible to transmit or utilize surround sound format data with the existing infrastructure.

### SUMMARY OF THE INVENTION

In accordance with the present invention, a system and method for an audio spatial environment engine are provided that overcome known problems with converting between spatial audio environments.

In particular, a system and method for an audio spatial environment engine are provided that allows conversion between N-channel data and M-channel data and conversion from M-channel data back to N′-channel data where N, M, and N′ are integers and where N is not necessarily equal to N′.

In accordance with an exemplary embodiment of the present invention, an audio spatial environment engine for converting from an N channel audio system to an M channel audio system and back to an N′ channel audio system, where N, M, and N′ are integers and where N is not necessarily equal to N′, is provided. The audio spatial environment engine includes a dynamic down-mixer that receives N channels of audio data and converts the N channels of audio data to M channels of audio data. The audio spatial environment engine also includes an up-mixer that receives the M channels of audio data and converts the M channels of audio data to N′ channels of audio data, where N is not necessarily equal to N′. One exemplary application of this system is for the transmission or storage of surround sound data across a network or infrastructure designed for stereo sound data. The dynamic down-mixing unit converts the surround sound data to stereo sound data for transmission or storage, and the up-mixing unit restores the stereo sound data to surround sound data for playback, processing, or some other suitable use.

The present invention provides many important technical advantages. One important technical advantage of the present invention is a system that provides improved and flexible conversions between different spatial environments due to an advanced dynamic down-mixing unit and a high-resolution frequency band up-mixing unit. The dynamic down-mixing unit includes an intelligent analysis and correction loop for correcting spectral, temporal, and spatial inaccuracies common to many down-mixing methods. The up-mixing unit utilizes the extraction and analysis of important inter-channel spatial cues across high-resolution frequency bands to derive the spatial placement of different frequency elements. The down-mixing and up-mixing units, when used either individually or as a system, provide improved sound quality and spatial distinction.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for dynamic down-mixing with an analysis and correction loop in accordance with an exemplary embodiment of the present invention;

FIG. 2 is a diagram of a system for down-mixing data from N channels to M channels in accordance with an exemplary embodiment of the present invention;

FIG. 3 is a diagram of a system for down-mixing data from 5 channels to 2 channels in accordance with an exemplary embodiment of the present invention;

FIG. 4 is a diagram of a sub-band vector calculation system in accordance with an exemplary embodiment of the present invention;

FIG. 5 is a diagram of a sub-band correction system in accordance with an exemplary embodiment of the present invention;

FIG. 6 is a diagram of a system for up-mixing data from M channels to N channels in accordance with an exemplary embodiment of the present invention;

FIG. 7 is a diagram of a system for up-mixing data from 2 channels to 5 channels in accordance with an exemplary embodiment of the present invention;

FIG. 8 is a diagram of a system for up-mixing data from 2 channels to 7 channels in accordance with an exemplary embodiment of the present invention;

FIG. 9 is a diagram of a method for extracting inter-channel spatial cues and generating a spatial channel filter for frequency domain applications in accordance with an exemplary embodiment of the present invention;

FIG. 10A is a diagram of an exemplary left front channel filter map in accordance with an exemplary embodiment of the present invention;

FIG. 10B is a diagram of an exemplary right front channel filter map;

FIG. 10C is a diagram of an exemplary center channel filter map;

FIG. 10D is a diagram of an exemplary left surround channel filter map; and

FIG. 10E is a diagram of an exemplary right surround channel filter map.

### DETAILED DESCRIPTION OF PREFERRED EMBODIMENTS

In the description that follows, like parts are marked throughout the specification and drawings with the same reference numerals. The drawing figures might not be to scale and certain components can be shown in generalized or schematic form and identified by commercial designations in the interest of clarity and conciseness.

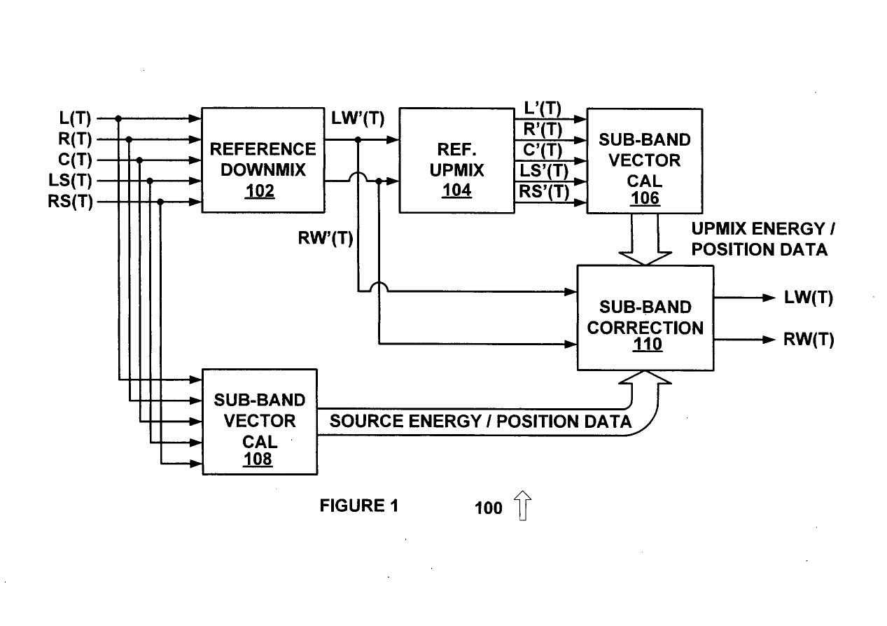

FIG. 1 is a diagram of a system 100 for dynamic down-mixing from an N-channel audio format to an M-channel audio format with an analysis and correction loop in accordance with an exemplary embodiment of the present invention. System 100 uses 5.1 channel sound (i.e. N=5) and converts the 5.1 channel sound to stereo sound (i.e. M=2), but other suitable numbers of input and output channels can also or alternatively be used.

The dynamic down-mix process of system 100 is implemented using reference down-mix 102, reference up-mix 104, sub-band vector calculation systems 106 and 108, and sub-band correction system 110. The analysis and correction loop is realized through reference up-mix 104, which simulates an up-mix process, sub-band vector calculation systems 106 and 108, which compute energy and position vectors per frequency band of the simulated up-mix and original signals, and sub-band correction system 110, which compares the energy and position vectors of the simulated up-mix and original signals and modifies the inter-channel spatial cues of the down-mixed signal to correct for any inconsistencies.

System 100 includes static reference down-mix 102, which converts the received N-channel audio to M-channel audio. Static reference down-mix 102 receives the 5.1 sound channels left L(T), right R(T), center C(T), left surround LS(T), and right surround RS(T) and converts the 5.1 channel signals into stereo channel signals left watermark LW′ (T) and right watermark RW′ (T).

The left watermark LW′ (T) and right watermark RW′ (T) stereo channel signals are subsequently provided to reference up-mix 104, which converts the stereo sound channels into 5.1 sound channels. Reference up-mix 104 outputs the 5.1 sound channels left L′ (T), right R′ (T), center C′ (T), left surround LS′ (T), and right surround RS′ (T).

The up-mixed 5.1 channel sound signals output from reference up-mix 104 are then provided to sub-band vector calculation system 106. The output from sub-band vector calculation system 106 is the up-mixed energy and image position data for a plurality of frequency bands for the up-mixed 5.1 channel signals L′ (T), R′ (T), C′ (T), LS′ (T), and RS′ (T). Likewise, the original 5.1 channel sound signals are provided to sub-band vector calculation system 108. The output from sub-band vector calculation system 108 is the source energy and image position data for a plurality of frequency bands for the original 5.1 channel signals L(T), R(T), C(T), LS(T), and RS(T). The energy and position vectors computed by sub-band vector calculation systems 106 and 108 consist of a total energy measurement and a 2-dimensional vector per frequency band which indicate the perceived intensity and source location for a given frequency element for a listener under ideal listening conditions. For example, an audio signal can be converted from the time domain to the frequency domain using an appropriate filter bank, such as a finite impulse response (FIR) filter bank, a quadrature mirror filter (QMF) bank, a discrete Fourier transform (DFT), a time-domain aliasing cancellation (TDAC) filter bank, or other suitable filter bank. The filter bank outputs are further processed to determine the total energy per frequency band and a normalized image position vector per frequency band.

The energy and position vector values output from sub-band vector calculation systems 106 and 108 are provided to sub-band correction system 110, which analyzes the source energy and position for the original 5.1 channel sound with the up-mixed energy and position for the 5.1 channel sound as it is generated from the left watermark LW′ (T) and right watermark RW′ (T) stereo channel signals. Differences between the source and up-mixed energy and position vectors are then identified and corrected per sub-band on the left watermark LW′ (T) and right watermark RW′ (T) signals producing LW(T) and RW(T) so as to provide a more accurate down-mixed stereo channel signal and more accurate 5.1 representation when the stereo channel signals are subsequently up-mixed. The corrected left watermark LW(T) and right watermark RW(T) signals are output for transmission, reception by a stereo receiver, reception by a receiver having up-mix functionality, or for other suitable uses.

In operation, system 100 dynamically down-mixes 5.1 channel sound to stereo sound through an intelligent analysis and correction loop, which consists of simulation, analysis, and correction of the entire down-mix/up-mix system. This methodology is accomplished by generating a statically down-mixed stereo signal LW′ (T) and RW′ (T), simulating the subsequent up-mixed signals L′ (T), R′ (T), C′ (T), LS′ (T), and RS′ (T), and analyzing those signals with the original 5.1 channel signals to identify and correct any energy or position vector differences on a sub-band basis that could affect the quality of the left watermark LW′ (T) and right watermark RW′ (T) stereo signals or subsequently up-mixed surround channel signals. The sub-band correction processing which produces left watermark LW(T) and right watermark RW(T) stereo signals is performed such that when LW(T) and RW(T) are up-mixed, the 5.1 channel sound that results matches the original input 5.1 channel sound with improved accuracy. Likewise, additional processing can be performed so as to allow any suitable number of input channels to be converted into a suitable number of watermarked output channels, such as 7.1 channel sound to watermarked stereo, 7.1 channel sound to watermarked 5.1 channel sound, custom sound channels (such as for automobile sound systems or theaters) to stereo, or other suitable conversions.

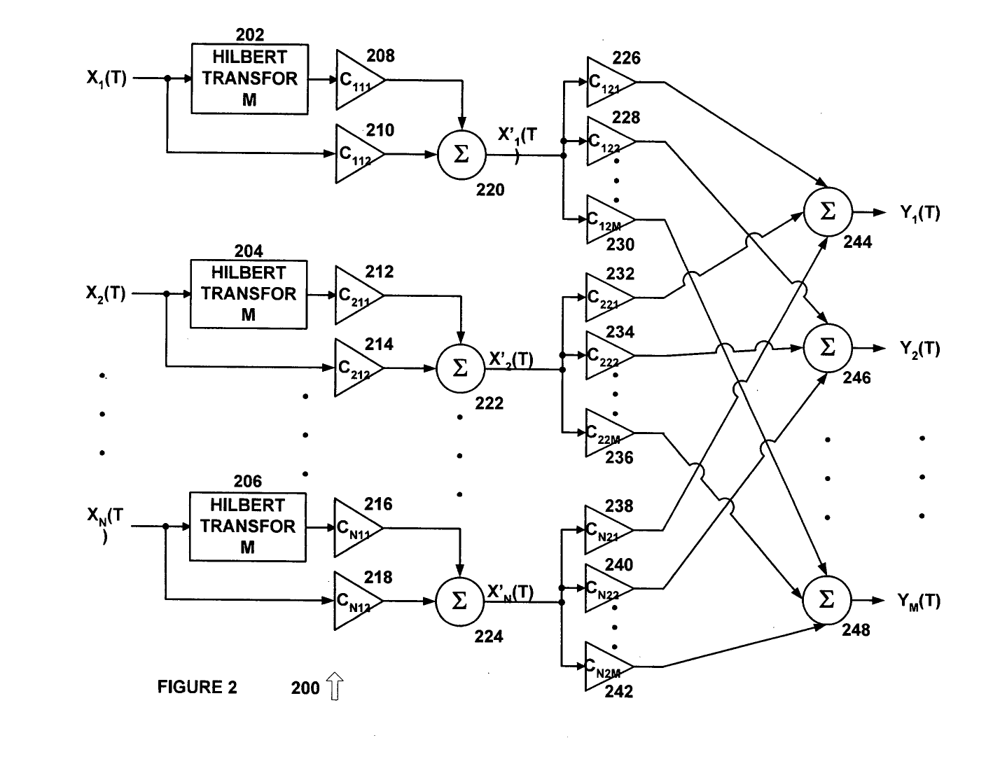

FIG. 2 is a diagram of a static reference down-mix 200 in accordance with an exemplary embodiment of the present invention. Static reference down-mix 200 can be used as reference down-mix 102 of FIG. 1 or in other suitable manners.

Reference down-mix 200 converts N channel audio to M channel audio, where N and M are integers and N is greater than M. Reference down-mix 200 receives input signals X₁(T), X₂(T), through X_{N}(T). For each input channel i, the input signal X₁(T) is provided to a Hilbert transform unit 202 through 206 which introduces a 90° phase shift of the signal. Other processing such as Hilbert filters or all-pass filter networks that achieve a 90° phase shift could also or alternately be used in place of the Hilbert transform unit. For each input channel i, the Hilbert transformed signal and the original input signal are then multiplied by a first stage of multipliers 208 through 218 with predetermined scaling constants Cᵢ₁₁ and Cᵢ₁₂, respectively, where the first subscript represents the input channel number i, the second subscript represents the first stage of multipliers, and the third subscript represents the multiplier number per stage. The outputs of multipliers 208 through 218 are then summed by summers 220 through 224, generating the fractional Hilbert signal X′ᵢ(T). The fractional Hilbert signals X′ᵢ(T) output from multipliers 220 through 224 have a variable amount of phase shift relative to the corresponding input signals Xᵢ(T). The amount of phase shift is dependent on the scaling constants Cᵢ₁₁ and Cᵢ₁₂, where 0° phase shift is possible corresponding to Cᵢ₁₁=0 and Cᵢ₁₂=1, and ±90° phase shift is possible corresponding to Cᵢ₁₁=±1 and Cᵢ₁₂=0. Any intermediate amount of phase shift is possible with appropriate values of Cᵢ₁₁ and Cᵢ₁₂.

Each signal X′ᵢ(T) for each input channel i is then multiplied by a second stage of multipliers 226 through 242 with predetermined scaling constant Cᵢ₂ⱼ, where the first subscript represents the input channel number i, the second subscript represents the second stage of multipliers, and the third subscript represents the output channel number j. The outputs of multipliers 226 through 242 are then appropriately summed by summers 244 through 248 to generate the corresponding output signal Yⱼ(T) for each output channel j. The scaling constants Cᵢ₂ⱼ for each input channel i and output channel j are determined by the spatial positions of each input channel i and output channel j. For example, scaling constants Cᵢ₂ⱼ for a left input channel i and right output channel j can be set near zero to preserve spatial distinction. Likewise, scaling constants Cᵢ₂ⱼ for a front input channel i and front output channel j can be set near one to preserve spatial placement.

In operation, reference down-mix 200 combines N sound channels into M sound channels in a manner that allows the spatial relationships among the input signals to be arbitrarily managed and extracted when the output signals are received at a receiver. Furthermore, the combination of the N channel sound as shown generates M channel sound that is of acceptable quality to a listener listening in an M channel audio environment. Thus, reference down-mix 200 can be used to convert N channel sound to M channel sound that can be used with an M channel receiver, an N channel receiver with a suitable up-mixer, or other suitable receivers.

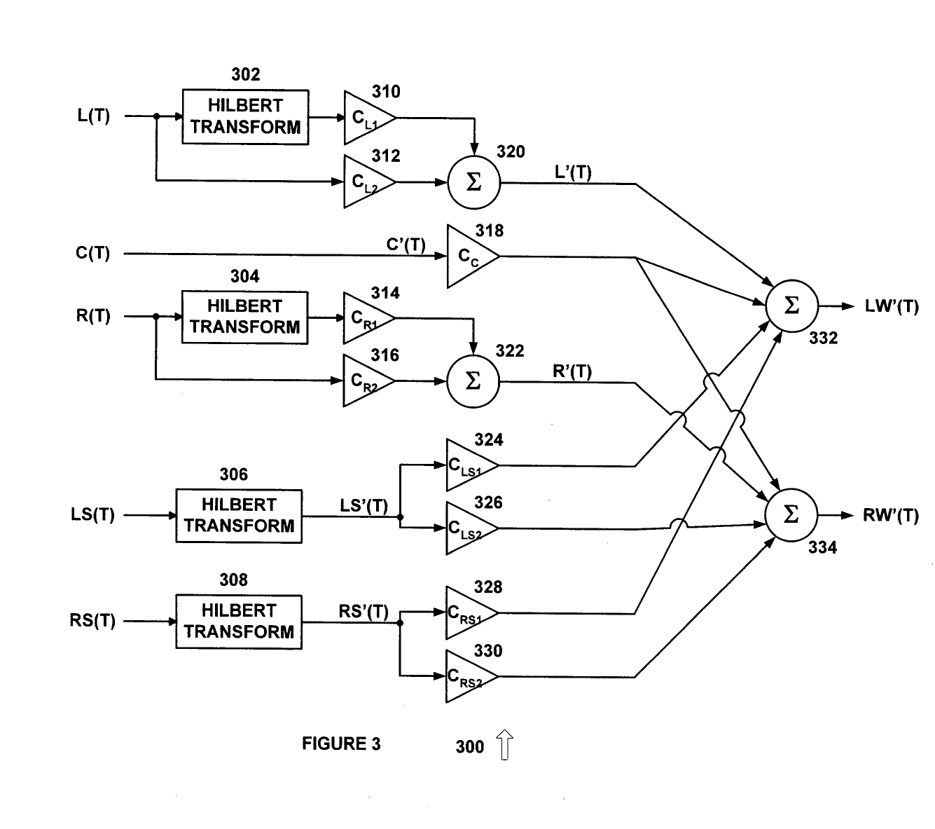

FIG. 3 is a diagram of a static reference down-mix 300 in accordance with an exemplary embodiment of the present invention. As shown in FIG. 3, static reference down-mix 300 is an implementation of static reference down-mix 200 of FIG. 2 which converts 5.1 channel time domain data into stereo channel time domain data. Static reference down-mix 300 can be used as reference down-mix 102 of FIG. 1 or in other suitable manners.

Reference down-mix 300 includes Hilbert transform 302, which receives the left channel signal L(T) of the source 5.1 channel sound, and performs a Hilbert transform on the time signal. The Hilbert transform introduces a 90° phase shift of the signal, which is then multiplied by multiplier 310 with a predetermined scaling constant C_{L1}. Other processing such as Hilbert filters or all-pass filter networks that achieve a 90° phase shift could also or alternately be used in place of the Hilbert transform unit. The original left channel signal L(T) is multiplied by multiplier 312 with a predetermined scaling constant C_{L2}. The outputs of multipliers 310 and 312 are summed by summer 320 to generate fractional Hilbert signal L′ (T). Likewise, the right channel signal R(T) from the source 5.1 channel sound is processed by Hilbert transform 304 and multiplied by multiplier 314 with a predetermined scaling constant C_{R1}. The original right channel signal R(T) is multiplied by multiplier 316 with a predetermined scaling constant C_{R2}. The outputs of multipliers 314 and 316 are summed by summer 322 to generate fractional Hilbert signal R′ (T). The fractional Hilbert signals L′ (T) and R′ (T) output from multipliers 320 and 322 have a variable amount of phase shift relative to the corresponding input signals L(T) and R(T), respectively. The amount of phase shift is dependent on the scaling constants C_{L1}, C_{L2}, C_{R1}, and C_{R2}, where 0° phase shift is possible corresponding to C_{L1}=0 and C_{L2}=1 and C_{R1}=0 and C_{R2}=1, and ±90° phase shift is possible corresponding to C_{L1}=±1 and C_{L2}=0 and C_{R1}=±1 and C_{R2}=0. Any intermediate amount of phase shift is possible with appropriate values of C_{L1}, C_{L2}, C_{R1}, and C_{R2}. The center channel input from the source 5.1 channel sound is provided to multiplier 318 as fractional Hilbert signal C′ (T), implying that no phase shift is performed on the center channel input signal. Multiplier 318 multiplies C′ (T) with a predetermined scaling constant C3, such as an attenuation by three decibels. The outputs of summers 320 and 322 and multiplier 318 are appropriately summed into the left watermark channel LW′ (T) and the right watermark channel RW′ (T).

The left surround channel LS(T) from the source 5.1 channel sound is provided to Hilbert transform 306, and the right surround channel RS(T) from the source 5.1 channel sound is provided to Hilbert transform 308. The outputs of Hilbert transforms 306 and 308 are fractional Hilbert signals LS′ (T) and RS′ (T), implying that a full 90° phase shift exists between the LS(T) and LS′ (T) signal pair and RS(T) and RS′ (T) signal pair. LS′ (T) is then multiplied by multipliers 324 and 326 with predetermined scaling constants C_{LS1} and C_{LS2}, respectively. Likewise, RS′ (T) is multiplied by multipliers 328 and 330 with predetermined scaling constants C_{RS1} and C_{RS2}, respectively. The outputs of multipliers 324 through 330 are appropriately provided to left watermark channel LW′ (T) and right watermark channel RW′ (T).

Summer 332 receives the left channel output from summer 320, the center channel output from multiplier 318, the left surround channel output from multiplier 324, and the right surround channel output from multiplier 328 and adds these signals to form the left watermark channel LW′ (T). Likewise, summer 334 receives the center channel output from multiplier 318, the right channel output from summer 322, the left surround channel output from multiplier 326, and the right surround channel output from multiplier 330 and adds these signals to form the right watermark channel RW′ (T).

In operation, reference down-mix 300 combines the source 5.1 sound channels in a manner that allows the spatial relationships among the 5.1 input channels to be maintained and extracted when the left watermark channel and right watermark channel stereo signals are received at a receiver. Furthermore, the combination of the 5.1 channel sound as shown generates stereo sound that is of acceptable quality to a listener using stereo receivers that do not perform a surround sound up-mix. Thus, reference down-mix 300 can be used to convert 5.1 channel sound to stereo sound that can be used with a stereo receiver, a 5.1 channel receiver with a suitable up-mixer, a 7.1 channel receiver with a suitable up-mixer, or other suitable receivers.

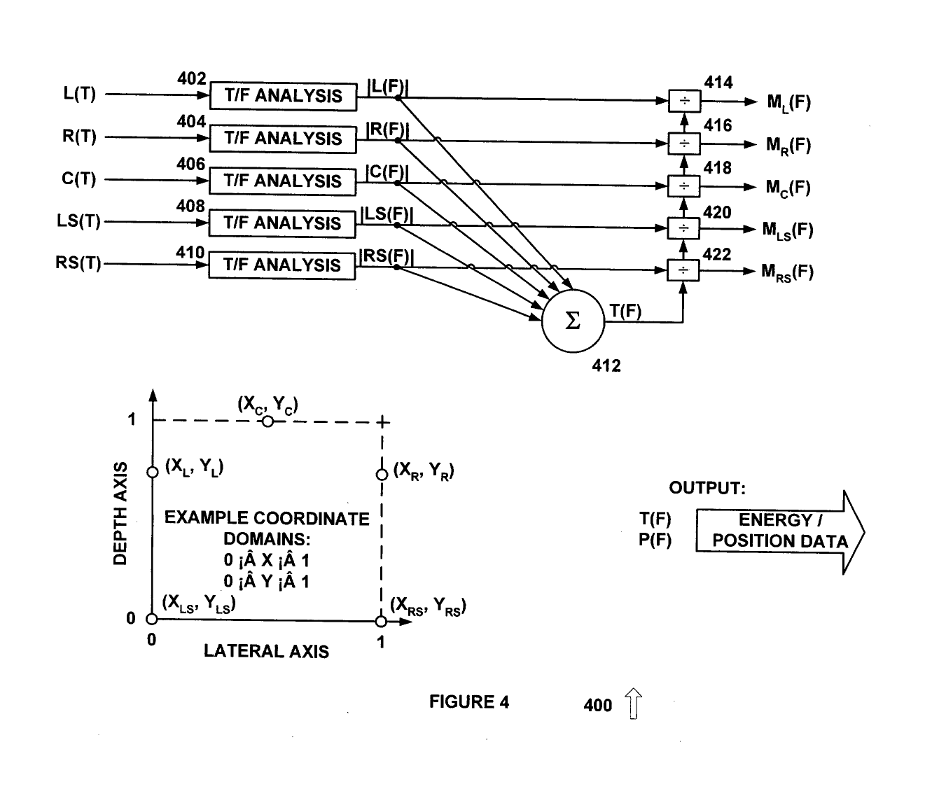

FIG. 4 is a diagram of a sub-band vector calculation system 400 in accordance with an exemplary embodiment of the present invention. Sub-band vector calculation system 400 provides energy and position vector data for a plurality of frequency bands, and can be used as sub-band vector calculation systems 106 and 108 of FIG. 1. Although 5.1 channel sound is shown, other suitable channel configurations can be used.

Sub-band vector calculation system 400 includes time-frequency analysis units 402 through 410. The 5.1 time domain sound channels L(T), R(T), C(T), LS(T), and RS(T) are provided to time-frequency analysis units 402 through 410, respectively, which convert the time domain signals into frequency domain signals. These time-frequency analysis units can be an appropriate filter bank, such as a finite impulse response (FIR) filter bank, a quadrature mirror filter (QMF) bank, a discrete Fourier transform (DFT), a time-domain aliasing cancellation (TDAC) filter bank, or other suitable filter bank. A magnitude or energy value per frequency band is output from time-frequency analysis units 402 through 410 for L(F), R(F), C(F), LS(F), and RS(F). These magnitude/energy values consist of a magnitude/energy measurement for each frequency band component of each corresponding channel. The magnitude/energy measurements are summed by summer 412, which outputs T(F), where T(F) is the total energy of the input signals per frequency band. This value is then divided into each of the channel magnitude/energy values by division units 414 through 422, to generate the corresponding normalized inter-channel level difference (ICLD) signals M_{L}(F), M_{R}(F), M_{C}(F), M_{LS}(F) and M_{RS}(F), where these ICLD signals can be viewed as normalized sub-band energy estimates for each channel.

The 5.1 channel sound is mapped to a normalized position vector as shown with exemplary locations on a 2-dimensional plane comprised of a lateral axis and a depth axis. As shown, the value of the location for (X_{LS}, Y_{LS}) is assigned to the origin, the value of (X_{RS}, Y_{RS}) is assigned to (0, 1), the value of (X_{L}, Y_{L}) is assigned to (0, 1-C), where C is a value between 1 and 0 representative of the setback distance for the left and right speakers from the back of the room. Likewise, the value of (X_{R}, Y_{R}) is (1, 1-C). Finally, the value for (X_{C}, Y_{C}) is (0.5, 1). These coordinates are exemplary, and can be changed to reflect the actual normalized location or configuration of the speakers relative to each other, such as where the speaker coordinates differ based on the size of the room, the shape of the room or other factors. For example, where 7.1 sound or other suitable sound channel configurations are used, additional coordinate values can be provided that reflect the location of speakers around the room. Likewise, such speaker locations can be customized based on the actual distribution of speakers in an automobile, room, auditorium, arena, or as otherwise suitable.

The estimated image position vector P(F) can be calculated per sub-band as set forth in the following vector equation:
P(F)=M_{L}(F)*(X_{L}, Y_{L})+M_{R}(F)*(X_{R}, Y_{R})+M_{C}(F)*(X_{C}, Y_{C})+i. M_{LS}(F)*(X_{LS}, Y_{LS})+M_{RS}(F)*(X_{RS}, Y_{RS})

Thus, for each frequency band, an output of total energy T(F) and a position vector P(F) are provided that are used to define the perceived intensity and position of the apparent frequency source for that frequency band. In this manner, the spatial image of a frequency component can be localized, such as for use with sub-band correction system 110 or for other suitable purposes.

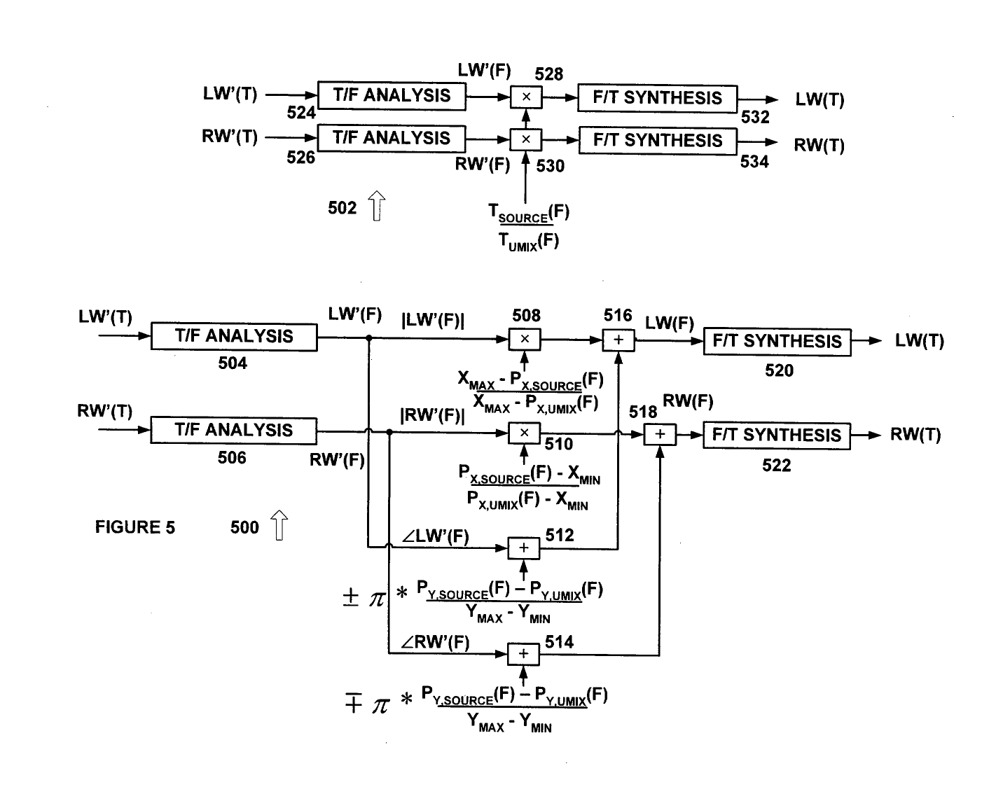

FIG. 5 is a diagram of a sub-band correction system in accordance with an exemplary embodiment of the present invention. The sub-band correction system can be used as sub-band correction system 110 of FIG. 1 or for other suitable purposes. The sub-band correction system receives left watermark LW′ (T) and right watermark RW′ (T) stereo channel signals and performs energy and image correction on the watermarked signal to compensate for signal inaccuracies for each frequency band that may be created as a result of reference down-mixing or other suitable method. The sub-band correction system receives and utilizes for each sub-band the total energy signals of the source T_{SOURCE}(F) and subsequent up-mixed signal T_{UMIX}(F) and position vectors for the source P_{SOURCE}(F) and subsequent up-mixed signal P_{UMIX}(F), such as those generated by sub-band vector calculation systems 106 and 108 of FIG. 1. These total energy signals and position vectors are used to determine the appropriate corrections and compensations to perform.

The sub-band correction system includes position correction system 500 and spectral energy correction system 502. Position correction system 500 receives time domain signals for left watermark stereo channel LW′ (T) and right watermark stereo channel RW′ (T), which are converted by time-frequency analysis units 504 and 506, respectively, from the time domain to the frequency domain. These time-frequency analysis units could be an appropriate filter bank, such as a finite impulse response (FIR) filter bank, a quadrature mirror filter (QMF) bank, a discrete Fourier transform (DFT), a time-domain aliasing cancellation (TDAC) filter bank, or other suitable filter bank.

The output of time-frequency analysis units 504 and 506 are frequency domain sub-band signals LW′ (F) and RW′ (F). Relevant spatial cues of inter-channel level difference (ICLD) and inter-channel coherence (ICC) are modified per sub-band in the signals LW′ (F) and RW′ (F). For example, these cues could be modified through manipulation of the magnitude or energy of LW′ (F) and RW′ (F), shown as the absolute value of LW′ (F) and RW′ (F), and the phase angle of LW′ (F) and RW′ (F). Correction of the ICLD is performed through multiplication of the magnitude/energy value of LW′ (F) by multiplier 508 with the value generated by the following equation:
[X_{MAX}−P_{X,SOURCE}(F)]/[X_{MAX}−P_{X,UMIX}(F)]
where
X_{MAX}=maximum X coordinate boundary
P_{X,SOURCE}(F)=estimated sub-band X position coordinate from source vector
P_{X,UMIX}(F)=estimated sub-band X position coordinate from subsequent up-mix vector
   Likewise, the magnitude/energy for RW′ (F) is multiplied by multiplier 510 with the value generated by the following equation:
   [P_{X,SOURCE}(F)−X_{MIN}]/[P_{X,UMIX}(F)−X_{MIN}]
   where
X_{MIN}=minimum X coordinate boundary

Correction of the ICC is performed through addition of the phase angle for LW′ (F) by adder 512 with the value generated by the following equation:
+/−π*[P_{Y,SOURCE}(F)−P_{Y,UMIX}(F)]/[Y_{MAX}−Y_{MIN}]
where
P_{Y,SOURCE}(F)=estimated sub-band Y position coordinate from source vector
P_{Y,UMIX}(F)=estimated sub-band Y position coordinate from subsequent up-mix vector
Y_{MAX}=maximum Y coordinate boundary
Y_{MIN}=minimum Y coordinate boundary

Likewise, the phase angle for RW′ (F) is added by adder 514 to the value generated by the following equation:
−/+π*[P_{Y,SOURCE}(F)−P_{Y,UMIX}(F)]/[Y_{MAX}−Y_{MIN}]
Note that the angular components added to LW′ (F) and RW′ (F) have equal value but opposite polarity, where the resultant polarities are determined by the leading phase angle between LW′ (F) and RW′ (F).

The corrected LW′ (F) magnitude/energy and LW′ (F) phase angle are recombined to form the complex value LW(F) for each sub-band by adder 516 and are then converted by frequency-time synthesis unit 520 into a left watermark time domain signal LW(T). Likewise, the corrected RW′ (F) magnitude/energy and RW′ (F) phase angle are recombined to form the complex value RW(F) for each sub-band by adder 518 and are then converted by frequency-time synthesis unit 522 into a right watermark time domain signal RW(T). The frequency-time synthesis units 520 and 522 can be a suitable synthesis filter bank capable of converting the frequency domain signals back to time domain signals.

As shown in this exemplary embodiment, the inter-channel spatial cues for each spectral component of the watermark left and right channel signals can be corrected using position correction 500 which appropriately modify the ICLD and ICC spatial cues.

Spectral energy correction system 502 can be used to ensure that the total spectral balance of the down-mixed signal is consistent with the total spectral balance of the original 5.1 signal, thus compensating for spectral deviations caused by comb filtering for example. The left watermark time domain signal and right watermark time domain signals LW′ (T) and RW′ (T) are converted from the time domain to the frequency domain using time-frequency analysis units 524 and 526, respectively. These time-frequency analysis units could be an appropriate filter bank, such as a finite impulse response (FIR) filter bank, a quadrature mirror filter (QMF) bank, a discrete Fourier transform (DFT), a time-domain aliasing cancellation (TDAC) filter bank, or other suitable filter bank. The output from time-frequency analysis units 524 and 526 is LW′ (F) and RW′ (F) frequency sub-band signals, which are multiplied by multipliers 528 and 530 by T_{SOURCE}(F)/T_{UMIX}(F), where
T_{SOURCE}(F)=|L(F)|+|R(F)|+|C(F)|+|LS(F)|+|RS(F)|
T_{UMIX}(F)=|L_{UMIX}(F)|+|R_{UMIX}(F)|+|C_{UMIX}(F)|+|LS_{UMIX}(F)|+|RS_{UMIX}(F)|

The output from multipliers 528 and 530 are then converted by frequency-time synthesis units 532 and 534 back from the frequency domain to the time domain to generate LW(T) and RW(T). The frequency-time synthesis unit can be a suitable synthesis filter bank capable of converting the frequency domain signals back to time domain signals. In this manner, position and energy correction can be applied to the down-mixed stereo channel signals LW′ (T) and RW′ (T) so as to create a left and right watermark channel signal LW(T) and RW(T) that is faithful to the original 5.1 signal. LW(T) and RW(T) can be played back in stereo or up-mixed back into 5.1 channel or other suitable numbers of channels without significantly changing the spectral component position or energy of the arbitrary content elements present in the original 5.1 channel sound.

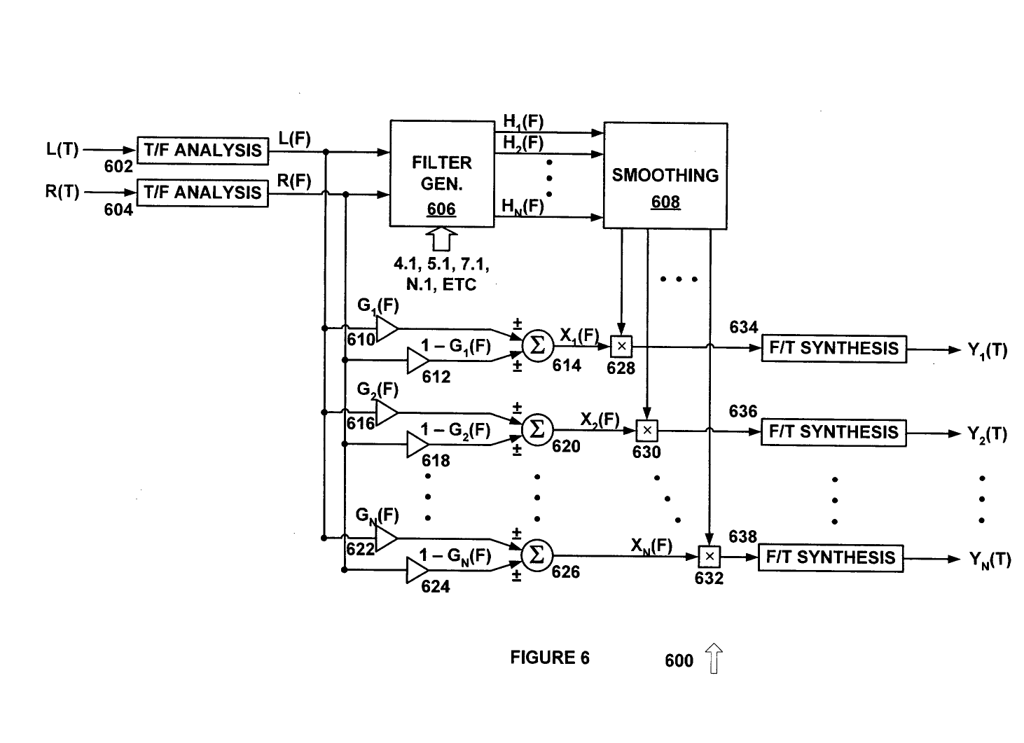

FIG. 6 is a diagram of a system 600 for up-mixing data from M channels to N channels in accordance with an exemplary embodiment of the present invention. System 600 converts stereo time domain data into N channel time domain data.

System 600 includes time-frequency analysis units 602 and 604, filter generation unit 606, smoothing unit 608, and frequency-time synthesis units 634 through 638. System 600 provides improved spatial distinction and stability in an up-mix process through a scalable frequency domain architecture, which allows for high resolution frequency band processing, and through a filter generation method which extracts and analyzes important inter-channel spatial cues per frequency band to derive the spatial placement of a frequency element in the up-mixed N channel signal.

System 600 receives a left channel stereo signal L(T) and a right channel stereo signal R(T) at time-frequency analysis units 602 and 604, which convert the time domain signals into frequency domain signals. These time-frequency analysis units could be an appropriate filter bank, such as a finite impulse response (FIR) filter bank, a quadrature mirror filter (QMF) bank, a discrete Fourier transform (DFT), a time-domain aliasing cancellation (TDAC) filter bank, or other suitable filter bank. The output from time-frequency analysis units 602 and 604 are a set of frequency domain values covering a sufficient frequency range of the human auditory system, such as a 0 to 20 kHz frequency range where the analysis filter bank sub-band bandwidths could be processed to approximate psycho-acoustic critical bands, equivalent rectangular bandwidths, or some other perceptual characterization. Likewise, other suitable numbers of frequency bands and ranges can be used.

The outputs from time-frequency analysis units 602 and 604 are provided to filter generation unit 606. In one exemplary embodiment, filter generation unit 606 can receive an external selection as to the number of channels that should be output for a given environment. For example, 4.1 sound channels where there are two front and two rear speakers can be selected, 5.1 sound systems where there are two front and two rear speakers and one front center speaker can be selected, 7.1 sound systems where there are two front, two side, two rear, and one front center speaker can be selected, or other suitable sound systems can be selected. Filter generation unit 606 extracts and analyzes inter-channel spatial cues such as inter-channel level difference (ICLD) and inter-channel coherence (ICC) on a frequency band basis. Those relevant spatial cues are then used as parameters to generate adaptive channel filters which control the spatial placement of a frequency band element in the up-mixed sound field. The channel filters are smoothed by smoothing unit 608 across both time and frequency to limit filter variability which could cause annoying fluctuation effects if allowed to vary too rapidly. In the exemplary embodiment shown in FIG. 6, the left and right channel L(F) and R(F) frequency domain signals are provided to filter generation unit 606 producing N channel filter signals H₁(F), H₂(F), through H_{N}(F) which are provided to smoothing unit 608.

Smoothing unit 608 averages frequency domain components for each channel of the N channel filters across both the time and frequency dimensions. Smoothing across time and frequency helps to control rapid fluctuations in the channel filter signals, thus reducing jitter artifacts and instability that can be annoying to a listener. In one exemplary embodiment, time smoothing can be realized through the application of a first-order low-pass filter on each frequency band from the current frame and the corresponding frequency band from the previous frame. This has the effect of reducing the variability of each frequency band from frame to frame. In another exemplary embodiment, spectral smoothing can be performed across groups of frequency bins which are modeled to approximate the critical band spacing of the human auditory system. For example, if an analysis filter bank with uniformly spaced frequency bins is employed, different numbers of frequency bins can be grouped and averaged for different partitions of the frequency spectrum. For example, from zero to five kHz, five frequency bins can be averaged, from 5 kHz to 10 kHz, 7 frequency bins can be averaged, and from 10 kHz to 20 kHz, 9 frequency bins can be averaged, or other suitable numbers of frequency bins and bandwidth ranges can be selected. The smoothed values of H₁(F), H₂(F) through H_{N}(F) are output from smoothing unit 608.

The source signals X₁(F), X₂(F), through X_{N}(F) for each of the N output channels are generated as an adaptive combination of the M input channels. In the exemplary embodiment shown in FIG. 6, for a given output channel i, the channel source signal Xᵢ(F) output from summers 614, 620, and 626 are generated as a sum of L(F) multiplied by the adaptive scaling signal Gᵢ(F) and R(F) multiplied by the adaptive scaling signal 1−Gᵢ(F). The adaptive scaling signals Gᵢ(F) used by multipliers 610, 612, 616, 618, 622, and 624 are determined by the intended spatial position of the output channel i and a dynamic inter-channel coherence estimate of L(F) and R(F) per frequency band. Likewise, the polarity of the signals provided to summers 614, 620, and 626 are determined by the intended spatial position of the output channel i. For example, adaptive scaling signals Gᵢ(F) and the polarities at summers 614, 620, and 626 can be designed to provide L(F)+R(F) combinations for front center channels, L(F) for left channels, R(F) for right channels, and L(F)−R(F) combinations for rear channels as is common in traditional matrix up-mixing methods. The adaptive scaling signals Gᵢ(F) can further provide a way to dynamically adjust the correlation between output channel pairs, whether they are lateral or depth-wise channel pairs.

The channel source signals X₁(F), X₂(F), through X_{N}(F) are multiplied by the smoothed channel filters H₁(F), H₂(F), through H_{N}(F) by multipliers 628 through 632, respectively.

The output from multipliers 628 through 632 is then converted from the frequency domain to the time domain by frequency-time synthesis units 634 through 638 to generate output channels Y₁(T), Y₂(T), through Y_{N}(T). In this manner, the left and right stereo signals are up-mixed to N channel signals, where inter-channel spatial cues that naturally exist or that are intentionally encoded into the left and right stereo signals, such as by the down-mixing watermark process of FIG. 1 or other suitable process, can be used to control the spatial placement of a frequency element within the N channel sound field produced by system 600. Likewise, other suitable combinations of inputs and outputs can be used, such as stereo to 7.1 sound, 5.1 to 7.1 sound, or other suitable combinations.

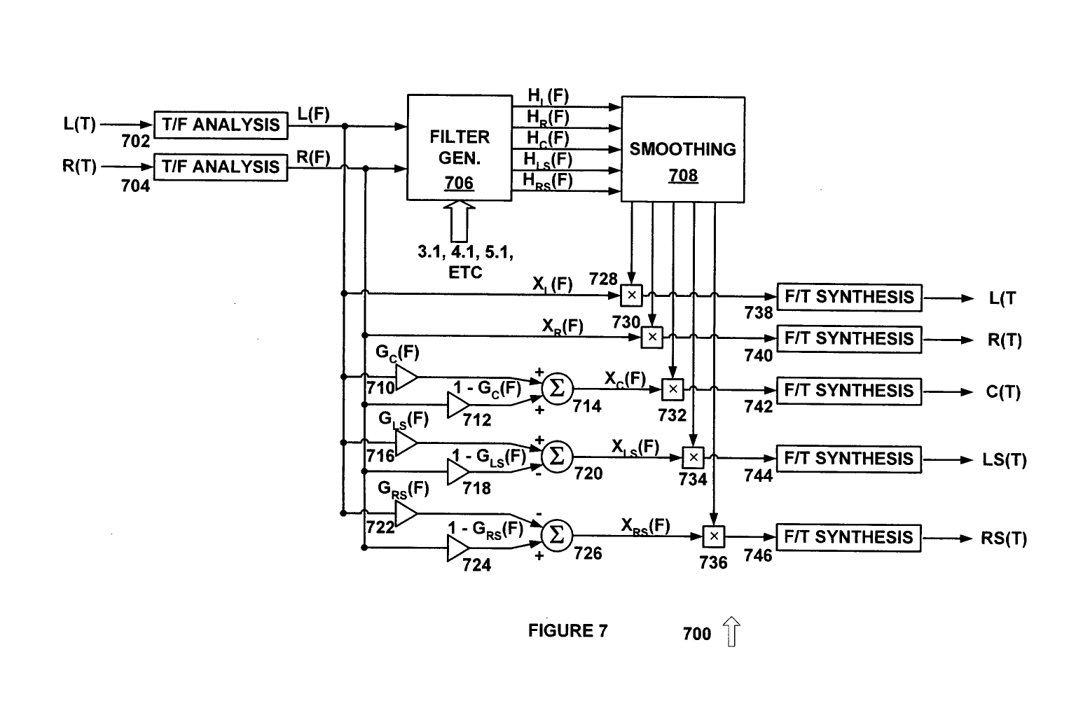

FIG. 7 is a diagram of a system 700 for up-mixing data from M channels to N channels in accordance with an exemplary embodiment of the present invention. System 700 converts stereo time domain data into 5.1 channel time domain data.

System 700 includes time-frequency analysis units 702 and 704, filter generation unit 706, smoothing unit 708, and frequency-time synthesis units 738 through 746. System 700 provides improved spatial distinction and stability in an up-mix process through the use of a scalable frequency domain architecture which allows for high resolution frequency band processing, and through a filter generation method which extracts and analyzes important inter-channel spatial cues per frequency band to derive the spatial placement of a frequency element in the up-mixed 5.1 channel signal.

System 700 receives a left channel stereo signal L(T) and a right channel stereo signal R(T) at time-frequency analysis units 702 and 704, which convert the time domain signals into frequency domain signals. These time-frequency analysis units could be an appropriate filter bank, such as a finite impulse response (FIR) filter bank, a quadrature mirror filter (QMF) bank, a discrete Fourier transform (DFT), a time-domain aliasing cancellation (TDAC) filter bank, or other suitable filter bank. The output from time-frequency analysis units 702 and 704 are a set of frequency domain values covering a sufficient frequency range of the human auditory system, such as a 0 to 20 kHz frequency range where the analysis filter bank sub-band bandwidths could be processed to approximate psycho-acoustic critical bands, equivalent rectangular bandwidths, or some other perceptual characterization. Likewise, other suitable numbers of frequency bands and ranges can be used.

The outputs from time-frequency analysis units 702 and 704 are provided to filter generation unit 706. In one exemplary embodiment, filter generation unit 706 can receive an external selection as to the number of channels that should be output for a given environment, such as 4.1 sound channels where there are two front and two rear speakers can be selected, 5.1 sound systems where there are two front and two rear speakers and one front center speaker can be selected, 3.1 sound systems where there are two front and one front center speaker can be selected, or other suitable sound systems can be selected. Filter generation unit 706 extracts and analyzes inter-channel spatial cues such as inter-channel level difference (ICLD) and inter-channel coherence (ICC) on a frequency band basis. Those relevant spatial cues are then used as parameters to generate adaptive channel filters which control the spatial placement of a frequency band element in the up-mixed sound field. The channel filters are smoothed by smoothing unit 708 across both time and frequency to limit filter variability which could cause annoying fluctuation effects if allowed to vary too rapidly. In the exemplary embodiment shown in FIG. 7, the left and right channel L(F) and R(F) frequency domain signals are provided to filter generation unit 706 producing 5.1 channel filter signals H_{L}(F), H_{R}(F), H_{C}(F), H_{LS}(F), and H_{RS}(F) which are provided to smoothing unit 708.

Smoothing unit 708 averages frequency domain components for each channel of the 5.1 channel filters across both the time and frequency dimensions. Smoothing across time and frequency helps to control rapid fluctuations in the channel filter signals, thus reducing jitter artifacts and instability that can be annoying to a listener. In one exemplary embodiment, time smoothing can be realized through the application of a first-order low-pass filter on each frequency band from the current frame and the corresponding frequency band from the previous frame. This has the effect of reducing the variability of each frequency band from frame to frame. In one exemplary embodiment, spectral smoothing can be performed across groups of frequency bins which are modeled to approximate the critical band spacing of the human auditory system. For example, if an analysis filter bank with uniformly spaced frequency bins is employed, different numbers of frequency bins can be grouped and averaged for different partitions of the frequency spectrum. In this exemplary embodiment, from zero to five kHz, five frequency bins can be averaged, from 5 kHz to 10 kHz, 7 frequency bins can be averaged, and from 10 kHz to 20 kHz, 9 frequency bins can be averaged, or other suitable numbers of frequency bins and bandwidth ranges can be selected. The smoothed values of H_{L}(F), H_{R}(F), H_{C}(F), H_{LS}(F), and H_{RS}(F) are output from smoothing unit 708.

The source signals X_{L}(F), X_{R}(F), X_{C}(F), X_{LS}(F), and X_{RS}(F) for each of the 5.1 output channels are generated as an adaptive combination of the stereo input channels. In the exemplary embodiment shown in FIG. 7, X_{L}(F) is provided simply as L(F), implying that G_{L}(F)=1 for all frequency bands. Likewise, X_{R}(F) is provided simply as R(F), implying that G_{R}(F)=0 for all frequency bands. X_{C}(F) as output from summer 714 is computed as a sum of the signals L(F) multiplied by the adaptive scaling signal G_{C}(F) with R(F) multiplied by the adaptive scaling signal 1−G_{C}(F). X_{LS}(F) as output from summer 720 is computed as a sum of the signals L(F) multiplied by the adaptive scaling signal G_{LS}(F) with R(F) multiplied by the adaptive scaling signal 1−G_{LS}(F) Likewise, X_{RS}(F) as output from summer 726 is computed as a sum of the signals L(F) multiplied by the adaptive scaling signal G_{RS}(F) with R(F) multiplied by the adaptive scaling signal 1−G_{RS}(F). Notice that if G_{C}(F)=0.5, G_{LS}(F)=0.5, and G_{RS}(F)=0.5 for all frequency bands, then the front center channel is sourced from an L(F)+R(F) combination and the surround channels are sourced from scaled L(F)−R(F) combinations as is common in traditional matrix up-mixing methods. The adaptive scaling signals G_{C}(F), G_{LS}(F), and G_{RS}(F) can further provide a way to dynamically adjust the correlation between adjacent output channel pairs, whether they are lateral or depth-wise channel pairs. The channel source signals X_{L}(F), X_{R}(F), X_{C}(F), X_{LS}(F), and X_{RS}(F) are multiplied by the smoothed channel filters H_{L}(F), H_{R}(F), H_{C}(F), H_{LS}(F), and H_{RS}(F) by multipliers 728 through 736, respectively.

The output from multipliers 728 through 736 are then converted from the frequency domain to the time domain by frequency-time synthesis units 738 through 746 to generate output channels Y_{L}(T), Y_{R}(T), Y_{C}(F), Y_{LS}(F), and Y_{RS}(T). In this manner, the left and right stereo signals are up-mixed to 5.1 channel signals, where inter-channel spatial cues that naturally exist or are intentionally encoded into the left and right stereo signals, such as by the down-mixing watermark process of FIG. 1 or other suitable process, can be used to control the spatial placement of a frequency element within the 5.1 channel sound field produced by system 700. Likewise, other suitable combinations of inputs and outputs can be used such as stereo to 4.1 sound, 4.1 to 5.1 sound, or other suitable combinations.

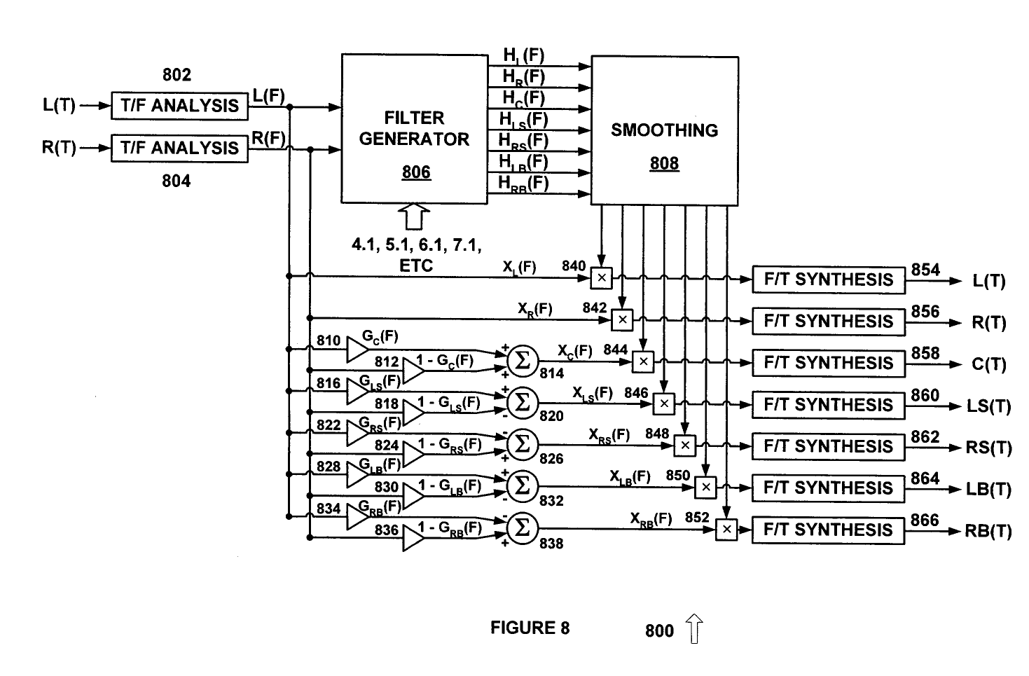

FIG. 8 is a diagram of a system 800 for up-mixing data from M channels to N channels in accordance with an exemplary embodiment of the present invention. System 800 converts stereo time domain data into 7.1 channel time domain data.

System 800 includes time-frequency analysis units 802 and 804, filter generation unit 806, smoothing unit 808, and frequency-time synthesis units 854 through 866. System 800 provides improved spatial distinction and stability in an up-mix process through a scalable frequency domain architecture, which allows for high resolution frequency band processing, and through a filter generation method which extracts and analyzes important inter-channel spatial cues per frequency band to derive the spatial placement of a frequency element in the up-mixed 7.1 channel signal.

System 800 receives a left channel stereo signal L(T) and a right channel stereo signal R(T) at time-frequency analysis units 802 and 804, which convert the time domain signals into frequency domain signals. These time-frequency analysis units could be an appropriate filter bank, such as a finite impulse response (FIR) filter bank, a quadrature mirror filter (QMF) bank, a discrete Fourier transform (DFT), a time-domain aliasing cancellation (TDAC) filter bank, or other suitable filter bank. The output from time-frequency analysis units 802 and 804 are a set of frequency domain values covering a sufficient frequency range of the human auditory system, such as a 0 to 20 kHz frequency range where the analysis filter bank sub-band bandwidths could be processed to approximate psycho-acoustic critical bands, equivalent rectangular bandwidths, or some other perceptual characterization. Likewise, other suitable numbers of frequency bands and ranges can be used.

The outputs from time-frequency analysis units 802 and 804 are provided to filter generation unit 806. In one exemplary embodiment, filter generation unit 806 can receive an external selection as to the number of channels that should be output for a given environment. For example, 4.1 sound channels where there are two front and two rear speakers can be selected, 5.1 sound systems where there are two front and two rear speakers and one front center speaker can be selected, 7.1 sound systems where there are two front, two side, two back, and one front center speaker can be selected, or other suitable sound systems can be selected. Filter generation unit 806 extracts and analyzes inter-channel spatial cues such as inter-channel level difference (ICLD) and inter-channel coherence (ICC) on a frequency band basis. Those relevant spatial cues are then used as parameters to generate adaptive channel filters which control the spatial placement of a frequency band element in the up-mixed sound field. The channel filters are smoothed by smoothing unit 808 across both time and frequency to limit filter variability which could cause annoying fluctuation effects if allowed to vary too rapidly. In the exemplary embodiment shown in FIG. 8, the left and right channel L(F) and R(F) frequency domain signals are provided to filter generation unit 806 producing 7.1 channel filter signals H_{L}(F), H_{R}(F), H_{C}(F), H_{LS}(F), H_{RS}(F), H_{LB}(F), and H_{RB}(F) which are provided to smoothing unit 808.

Smoothing unit 808 averages frequency domain components for each channel of the 7.1 channel filters across both the time and frequency dimensions. Smoothing across time and frequency helps to control rapid fluctuations in the channel filter signals, thus reducing jitter artifacts and instability that can be annoying to a listener. In one exemplary embodiment, time smoothing can be realized through the application of a first-order low-pass filter on each frequency band from the current frame and the corresponding frequency band from the previous frame. This has the effect of reducing the variability of each frequency band from frame to frame. In one exemplary embodiment, spectral smoothing can be performed across groups of frequency bins which are modeled to approximate the critical band spacing of the human auditory system. For example, if an analysis filter bank with uniformly spaced frequency bins is employed, different numbers of frequency bins can be grouped and averaged for different partitions of the frequency spectrum. In this exemplary embodiment, from zero to five kHz, five frequency bins can be averaged, from 5 kHz to 10 kHz, 7 frequency bins can be averaged, and from 10 kHz to 20 kHz, 9 frequency bins can be averaged, or other suitable numbers of frequency bins and bandwidth ranges can be selected. The smoothed values of H_{L}(F), H_{R}(F), H_{C}(F), H_{LS}(F), H_{RS}(F), H_{LB}(F), and H_{RB}(F) are output from smoothing unit 808.

The source signals X_{L}(F), X_{R}(F), X_{C}(F), X_{LS}(F), X_{RS}(F), X_{LB}(F), and X_{RB}(F) for each of the 7.1 output channels are generated as an adaptive combination of the stereo input channels. In the exemplary embodiment shown in FIG. 8, X_{L}(F) is provided simply as L(F), implying that G_{L}(F)=1 for all frequency bands. Likewise, X_{R}(F) is provided simply as R(F), implying that G_{R}(F)=0 for all frequency bands. X_{C}(F) as output from summer 814 is computed as a sum of the signals L(F) multiplied by the adaptive scaling signal G_{C}(F) with R(F) multiplied by the adaptive scaling signal 1−G_{C}(F). X_{LS}(F) as output from summer 820 is computed as a sum of the signals L(F) multiplied by the adaptive scaling signal G_{LS}(F) with R(F) multiplied by the adaptive scaling signal 1−G_{LS}(F). Likewise, X_{RS}(F) as output from summer 826 is computed as a sum of the signals L(F) multiplied by the adaptive scaling signal G_{RS}(F) with R(F) multiplied by the adaptive scaling signal 1−G_{RS}(F). Likewise, X_{LB}(F) as output from summer 832 is computed as a sum of the signals L(F) multiplied by the adaptive scaling signal G_{LB}(F) with R(F) multiplied by the adaptive scaling signal 1−G_{LB}(F). Likewise, X_{RB}(F) as output from summer 838 is computed as a sum of the signals L(F) multiplied by the adaptive scaling signal G_{RB}(F) with R(F) multiplied by the adaptive scaling signal 1−G_{RB}(F). Notice that if G_{C}(F)=0.5, G_{LS}(F)=0.5, G_{RS}(F)=0.5, G_{LB}(F)=0.5, and G_{RB}(F)=0.5 for all frequency bands, then the front center channel is sourced from an L(F)+R(F) combination and the side and back channels are sourced from scaled L(F)−R(F) combinations as is common in traditional matrix up-mixing methods. The adaptive scaling signals G_{C}(F), G_{LS}(F), G_{RS}(F), G_{LB}(F), and G_{RB}(F) can further provide a way to dynamically adjust the correlation between adjacent output channel pairs, whether they be lateral or depth-wise channel pairs. The channel source signals X_{L}(F), X_{R}(F), X_{C}(F), X_{LS}(F), X_{RS}(F), X_{LB}(F), and X_{RB}(F) are multiplied by the smoothed channel filters H_{L}(F), H_{R}(F), H_{C}(F), H_{LS}(F), H_{RS}(F), H_{LB}(F), and H_{RB}(F) by multipliers 840 through 852, respectively.

The output from multipliers 840 through 852 are then converted from the frequency domain to the time domain by frequency-time synthesis units 854 through 866 to generate output channels Y_{L}(T), Y_{R}(T), Y_{C}(F), Y_{LS}(F), Y_{RS}(T), Y_{LB}(T) and Y_{RB}(T). In this manner, the left and right stereo signals are up-mixed to 7.1 channel signals, where inter-channel spatial cues that naturally exist or are intentionally encoded into the left and right stereo signals, such as by the down-mixing watermark process of FIG. 1 or other suitable process, can be used to control the spatial placement of a frequency element within the 7.1 channel sound field produced by system 800. Likewise, other suitable combinations of inputs and outputs can be used such as stereo to 5.1 sound, 5.1 to 7.1 sound, or other suitable combinations.

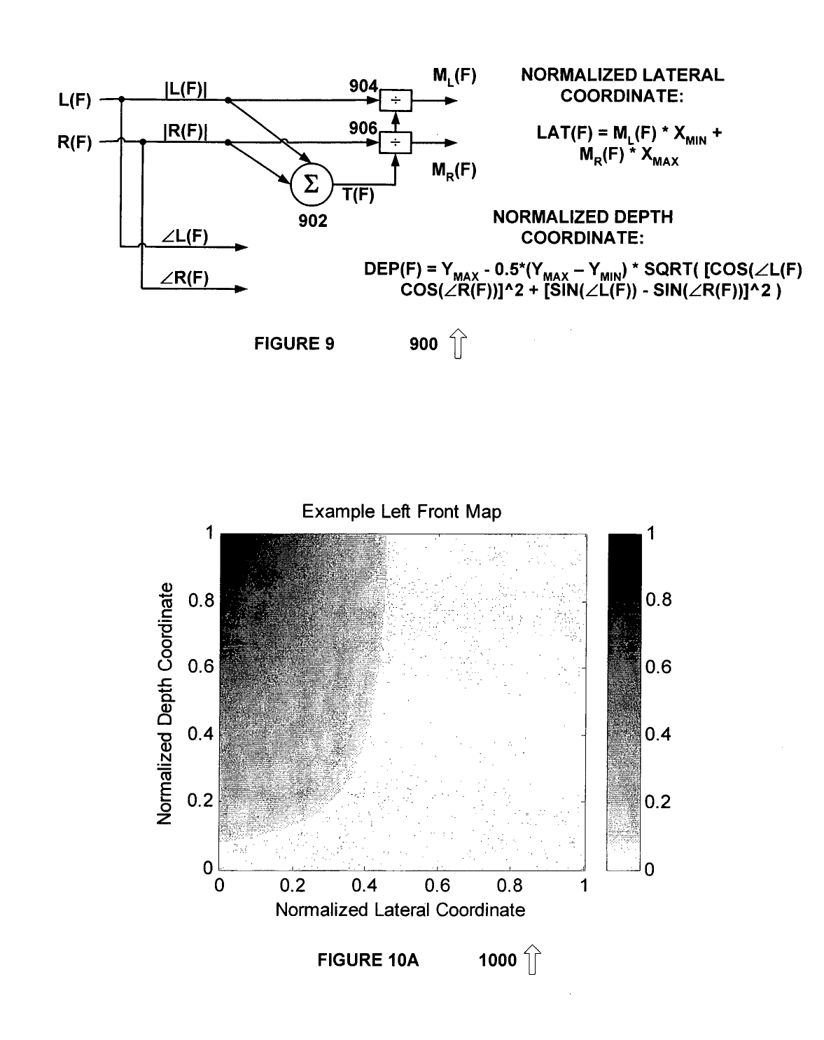

FIG. 9 is a diagram of a system 900 for generating a filter for frequency domain applications in accordance with an exemplary embodiment of the present invention. The filter generation process employs frequency domain analysis and processing of an M channel input signal. Relevant inter-channel spatial cues are extracted for each frequency band of the M channel input signals, and a spatial position vector is generated for each frequency band. This spatial position vector is interpreted as the perceived source location for that frequency band for a listener under ideal listening conditions. Each channel filter is then generated such that the resulting spatial position for that frequency element in the up-mixed N channel output signal is reproduced consistently with the inter-channel cues. Estimates of the inter-channel level differences (ICLD's) and inter-channel coherence (ICC) are used as the inter-channel cues to create the spatial position vector.

In the exemplary embodiment shown in system 900, sub-band magnitude or energy components are used to estimate inter-channel level differences, and sub-band phase angle components are used to estimate inter-channel coherence. The left and right frequency domain inputs L(F) and R(F) are converted into a magnitude or energy component and phase angle component where the magnitude/energy component is provided to summer 902 which computes a total energy signal T(F) which is then used to normalize the magnitude/energy values of the left M_{L}(F) and right channels M_{R}(F) for each frequency band by dividers 904 and 906, respectively. A normalized lateral coordinate signal LAT(F) is then computed from M_{L}(F) and M_{R}(F), where the normalized lateral coordinate for a frequency band is computed as:
LAT(F)=M_{L}(F)*X_{MIN}+M_{R}(F)*X_{MAX}

Likewise, a normalized depth coordinate is computed from the phase angle components of the input as:
DEP(F)=Y_{MAX}−0.5*(Y_{MAX}−Y_{MIN})*sqrt([COS(/L(F))−COS(/R(F))]ˆ2+[SIN(/L(F))−SIN(/R(F))]ˆ2

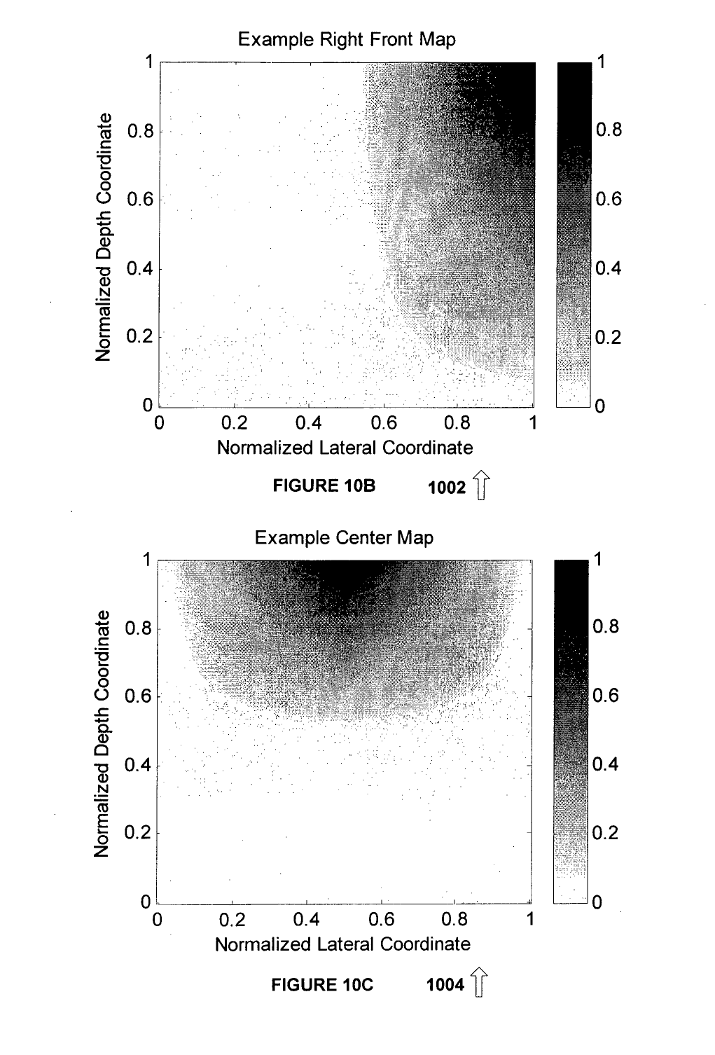

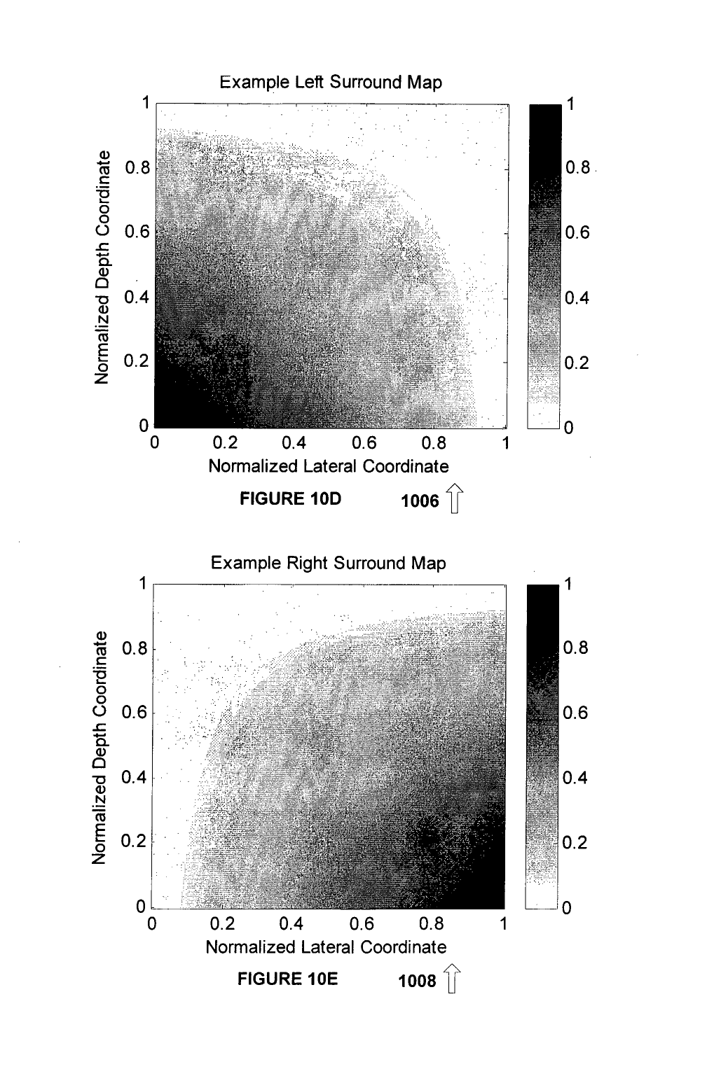

The normalized depth coordinate is calculated essentially from a scaled and shifted distance measurement between the phase angle components /L(F) and /R(F). The value of DEP(F) approaches 1 as the phase angles /L(F) and /R(F) approach one another on the unit circle, and DEP(F) approaches 0 as the phase angles /L(F) and /R(F) approach opposite sides of the unit circle. For each frequency band, the normalized lateral coordinate and depth coordinate form a 2-dimensional vector (LAT(F), DEP(F)) which is input into a 2-dimensional channel map, such as those shown in the following FIGS. 10A through 10E, to produce a filter value Hᵢ(F) for each channel i. These channel filters Hᵢ(F) for each channel i are output from the filter generation unit, such as filter generation unit 606 of FIG. 6, filter generation unit 706 of FIG. 7, and filter generation unit 806 of FIG. 8.

FIG. 10A is a diagram of a filter map for a left front signal in accordance with an exemplary embodiment of the present invention. In FIG. 10A, filter map 1000 accepts a normalized lateral coordinate ranging from 0 to 1 and a normalized depth coordinate ranging from 0 to 1 and outputs a normalized filter value ranging from 0 to 1. Shades of gray are used to indicate variations in magnitude from a maximum of 1 to a minimum of 0, as shown by the scale on the right-hand side of filter map 1000. For this exemplary left front filter map 1000, normalized lateral and depth coordinates approaching (0, 1) would output the highest filter values approaching 1.0, whereas the coordinates ranging from approximately (0.6, Y) to (1.0, Y), where Y is a number between 0 and 1, would essentially output filter values of 0.

FIG. 10B is a diagram of exemplary right front filter map 1002. Filter map 1002 accepts the same normalized lateral coordinates and normalized depth coordinates as filter map 1000, but the output filter values favor the right front portion of the normalized layout.

FIG. 10C is a diagram of exemplary center filter map 1004. In this exemplary embodiment, the maximum filter value for the center filter map 1004 occurs at the center of the normalized layout, with a significant drop off in magnitude as coordinates move away from the front center of the layout towards the rear of the layout.

FIG. 10D is a diagram of exemplary left surround filter map 1006. In this exemplary embodiment, the maximum filter value for the left surround filter map 1006 occurs near the rear left coordinates of the normalized layout and drop in magnitude as coordinates move to the front and right sides of the layout.

FIG. 10E is a diagram of exemplary right surround filter map 1008. In this exemplary embodiment, the maximum filter value for the right surround filter map 1008 occurs near the rear right coordinates of the normalized layout and drop in magnitude as coordinates move to the front and left sides of the layout.

Likewise, if other speaker layouts or configurations are used, then existing filter maps can be modified and new filter maps corresponding to new speaker locations can be generated to reflect changes in the new listening environment. In one exemplary embodiment, a 7.1 system would include two additional filter maps with the left surround and right surround being moved upwards in the depth coordinate dimension and with the left back and right back locations having filter maps similar to filter maps 1006 and 1008, respectively. The rate at which the filter factor drops off can be changed to accommodate different numbers of speakers.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. An audio spatial environment engine for converting from an N channel audio system to an M channel audio system, where M and N are integers and N is greater than M, comprising:
a reference down-mixer receiving N channels of audio data and converting the N channels of audio data to M channels of audio data;
a reference up-mixer receiving the M channels of audio data and converting the M channels of audio data to N′ channels of audio data; and
a correction system receiving the M channels of audio data, the N channels of audio data, and the N′ channels of audio data and correcting the M channels of audio data based on differences between the N channels of audio data and the N′ channels of audio data.

2. The system of claim 1 wherein the correction system further comprises:
a first sub-band vector calibration unit receiving the N channels of audio data and generating a first plurality of sub-bands of audio spatial image data;
a second sub-band vector calibration unit receiving the N′ channels of audio data and generating a second plurality of sub-bands of audio spatial image data; and
the correction system receiving the first plurality of sub-bands of audio spatial image data and the second plurality of sub-bands of audio spatial image data and correcting the M channels of audio data based on differences between the first plurality of sub-bands of audio spatial image data and the second plurality of sub-bands of audio spatial image data.

3. The system of claim 2 wherein each of the first plurality of sub-bands of audio spatial image data and the second plurality of sub-bands of audio spatial image data has an associated energy value and position value.

4. The system of claim 3 wherein each of the position values represents the apparent location of a center of the associated sub-band of audio spatial image data in two-dimensional space, where a coordinate of the center is determined by a vector sum of an energy value associated with each of N speakers and a coordinate of each of the N speakers.

5. The system of claim 1 wherein the reference down-mixer further comprises a plurality of fractional Hilbert stages, each receiving one of the N channels of audio data and applying a predetermined phase shift to the associated channel of audio data.

6. The system of claim 5 wherein the reference down-mixer further comprises a plurality of summation stages coupled to plurality of fractional Hilbert stages and combining the output from the Hilbert stages in a predetermined manner to generate the M channels of audio data.

7. The system of claim 1 wherein the reference up-mixer further comprises:
a time domain to frequency domain conversion stage receiving the M channels of audio data and generating a plurality of sub-bands of audio spatial image data;
a filter generator receiving the M channels of the plurality of sub-bands of audio spatial image data and generating N′ channels of a plurality of sub-bands of audio spatial image data;
a smoothing stage receiving the N′ channels of the plurality of sub-bands of audio spatial image data and averaging each sub-band with one or more adjacent sub-bands;
a summation stage coupled to the smoothing stage and receiving the M channels of the plurality of sub-bands of audio spatial image data and the smoothed N′ channels of the plurality of sub-bands of audio spatial image data and generating scaled N′ channels of the plurality of sub-bands of audio spatial image data; and
a frequency domain to time domain conversion stage receiving the scaled N′ channels of the plurality of sub-bands of audio spatial image data and generating the N′ channels of audio data.

8. The system of claim 1 wherein the correction system further comprises:
a first sub-band vector calibration stage comprising:
a time domain to frequency domain conversion stage receiving the N channels of audio data and generating a first plurality of sub-bands of audio spatial image data;
a first sub-band energy stage receiving the first plurality of sub-bands of audio spatial image data and generating a first energy value for each sub-band; and
a first sub-band position stage receiving the first plurality of sub-bands of audio spatial image data and generating a first position vector for each sub-band.

9. The system of claim 8 wherein the correction system further comprises:
a second sub-band vector calibration stage comprising:
a second sub-band energy stage receiving a second plurality of sub-bands of audio spatial image data and generating a second energy value for each sub-band; and
a second sub-band position stage receiving the second plurality of sub-bands of audio spatial image data and generating a second position vector for each sub-band.

10. A method for converting from an N channel audio system to an M channel audio system, where N and M are integers and N is greater than M, comprising:
converting N channels of audio data to M channels of audio data;
converting the M channels of audio data to N′ channels of audio data; and
correcting the M channels of audio data based on differences between the N channels of audio data and the N′ channels of audio data.

11. The method of claim 10 wherein converting the N channels of audio data to the M channels of audio data comprises:
processing one or more of the N channels of audio data with a fractional Hilbert function to apply a predetermined phase shift to the associated channel of audio data; and
combining one or more of the N channels of audio data after processing with the fractional Hilbert function to create the M channels of audio data, such that the combination of the one or more of the N channels of audio data in each of the M channels of audio data has a predetermined phase relationship.

12. The method of claim 10 wherein converting the M channels of audio data to the N′ channels of audio data comprises:
converting the M channels of audio data from a time domain to a plurality of sub-bands in frequency domain;
filtering the plurality of sub-bands of the M channels to generate a plurality of sub-bands of N channels;
smoothing the plurality of sub-bands of the N channels by averaging each sub-band with one or more adjacent bands;
multiplying each of the plurality of sub-bands of the N channels by one or more of the corresponding sub-bands of the M channels; and
converting the plurality of sub-bands of the N channels from the frequency domain to the time domain.

13. The method of claim 10 wherein correcting the M channels of audio data based on differences between the N channels of audio data and the N′ channels of audio data comprises:
determining an energy and position vector for each of a plurality of sub-bands of the N channels of audio data;
determining an energy and position vector for each of a plurality of sub-bands of the N′ channels of audio data; and
correcting one or more sub-bands of the M channels of audio data if a difference in the energy and the position vector for the corresponding sub-bands of the N channels of audio data and the N′ channels of audio data is greater than an allowable tolerance.

14. The method of claim 13 wherein correcting one or more sub-bands of the M channels of audio data comprises adjusting an energy and a position vector for the sub-bands of the M channels of audio data such that the adjusted sub-bands of the M channels of audio data are converted into adjusted N′ channels of audio data having one or more sub-band energy and position vectors that are closer to the energy and the position vectors of the sub-bands of the N channels of audio data than the unadjusted energy and position vector for each of a plurality of sub-bands of the N′ channels of audio data.

15. An audio spatial environment engine for converting from an N channel audio system to an M channel audio system, where M and N are integers and N is greater than M, comprising:
down-mixer means for receiving N channels of audio data and converting the N channels of audio data to M channels of audio data;
up-mixer means for receiving the M channels of audio data and converting the M channels of audio data to N′ channels of audio data; and
correction means for receiving the M channels of audio data, the N channels of audio data, and the N′ channels of audio data and correcting the M channels of audio data based on differences between the N channels of audio data and the N′ channels of audio data.

16. The system of claim 15 wherein the correction means further comprises:
first sub-band vector calibration means for receiving the N channels of audio data and generating a first plurality of sub-bands of audio spatial image data;
second sub-band vector calibration means for receiving the N′ channels of audio data and generating a second plurality of sub-bands of audio spatial image data; and
the correction means for receiving the first plurality of sub-bands of audio spatial image data and the second plurality of sub-bands of audio spatial image data and correcting the M channels of audio data based on differences between the first plurality of sub-bands of audio spatial image data and the second plurality of sub-bands of audio spatial image data.

17. The system of claim 15 wherein the down-mixer means further comprises a plurality of fractional Hilbert means for receiving one of the N channels of audio data and applying a predetermined phase shift to the associated channel of audio data.

18. The system of claim 15 wherein the up-mixer means further comprises:
time domain to frequency domain conversion means for receiving the M channels of audio data and generating a plurality of sub-bands of audio spatial image data;
filter generator means for receiving the M channels of the plurality of sub-bands of audio spatial image data and generating N′ channels of a plurality of sub-bands of audio spatial image data;
smoothing means for receiving the N′ channels of the plurality of sub-bands of audio spatial image data and averaging each sub-band with one or more adjacent sub-bands;
summation means for receiving the M channels of the plurality of sub-bands of audio spatial image data and the smoothed N′ channels of the plurality of sub-bands of audio spatial image data and generating scaled N′ channels of the plurality of sub-bands of audio spatial image data; and
frequency domain to time domain conversion means for receiving the scaled N′ channels of the plurality of sub-bands of audio spatial image data and generating the N′ channels of audio data.

19. An audio spatial environment engine for converting from an N channel audio system to an M channel audio system, where N and M are integers and N is greater than M, comprising:
one or more Hilbert transform stages each receiving one of the N channels of audio data and applying a predetermined phase shift to the associated channel of audio data;
one or more constant multiplier stages each receiving one of the Hilbert transformed channels of audio data and each generating a scaled Hilbert transformed channel of audio data;
one or more first summation stages each receiving the one of the N channels of audio data and the scaled Hilbert transformed channel of audio data and each generating a fractional Hilbert channel of audio data; and
M second summation stages each receiving one or more of the fractional Hilbert channels of audio data and one or more of the N channels of audio data and combining each of the one or more of the fractional Hilbert channels of audio data and the one or more of the N channels of audio data to generate one of M channels of audio data having a predetermined phase relationship between each the one or more of the fractional Hilbert channels of audio data and the one or more of the N channels of audio data.

20. The audio spatial environment engine of claim 19 comprising a Hilbert transform stage receiving a left channel of audio data, where the Hilbert transformed left channel of audio data is multiplied by a constant and added to the left channel of audio data to generate a left channel of audio data having a predetermined phase shift, the phase-shifted left channel of audio data is multiplied by a constant and provided to one or more of the M second summation stages.

21. The audio spatial environment engine of claim 19 comprising a Hilbert transform stage receiving a right channel of audio data, where the Hilbert transformed right channel of audio data is multiplied by a constant and subtracted from the right channel of audio data to generate a right channel of audio data having a predetermined phase shift, the phase-shifted right channel of audio data is multiplied by a constant and provided to one or more of the M second summation stages.

22. The audio spatial environment engine of claim 19 comprising a Hilbert transform stage receiving a left surround channel of audio data and a Hilbert transform stage receiving a right surround channel of audio data, where the Hilbert transformed left surround channel of audio data is multiplied by a constant and added to the Hilbert transformed right surround channel of audio data to generate a left-right surround channel of audio data, the phase-shifted left-right surround channel of audio data is provided to one or more of the M second summation stages.

23. The audio spatial environment engine of claim 19 comprising a Hilbert transform stage receiving a right surround channel of audio data and a Hilbert transform stage receiving a left surround channel of audio data, where the Hilbert transformed right surround channel of audio data is multiplied by a constant and added to the Hilbert transformed left surround channel of audio data to generate a right-left surround channel of audio data, the phase-shifted right-left surround channel of audio data is provided to one or more of the M second summation stages.

24. The audio spatial environment engine of claim 19 comprising:
a Hilbert transform stage receiving a left channel of audio data, where the Hilbert transformed left channel of audio data is multiplied by a constant and added to the left channel of audio data to generate a left channel of audio data having a predetermined phase shift, the left channel of audio data is multiplied by a constant to generate a scaled left channel of audio data;
a Hilbert transform stage receiving a right channel of audio data, where the Hilbert transformed right channel of audio data is multiplied by a constant and subtracted from the right channel of audio data to generate a right channel of audio data having a predetermined phase shift, the right channel of audio data is multiplied by a constant to generate a scaled right channel of audio data; and
a Hilbert transform stage receiving a left surround channel of audio data and a Hilbert transform stage receiving a right surround channel of audio data, where the Hilbert transformed left surround channel of audio data is multiplied by a constant and added to the Hilbert transformed right surround channel of audio data to generate a left-right surround channel of audio data, and the Hilbert transformed right surround channel of audio data is multiplied by a constant and added to the Hilbert transformed left surround channel of audio data to generate a right-left surround channel of audio data.

25. The audio spatial environment engine of claim 24 comprising:
a first of M second summation stages that receives the scaled left channel of audio data, the right-left channel of audio data and a scaled center channel of audio data and which adds the scaled left channel of audio data, the right-left channel of audio data and the scaled center channel of audio data to form a left watermarked channel of audio data; and
a second of M second summation stages that receives the scaled right channel of audio data, the left-right channel of audio data and the scaled center channel of audio data and which adds the scaled channel of audio data and the scaled center channel of audio data and subtracts from the sum the left-right channel of audio data and to form a right watermarked channel of audio data.

26. A method for converting from an N channel audio system to an M channel audio system, where N and M are integers and N is greater than M, comprising:
processing one or more of the N channels of audio data with a fractional Hilbert function to apply a predetermined phase shift to the associated channel of audio data; and
combining one or more of the N channels of audio data after processing with the fractional Hilbert function to create the M channels of audio data, such that the combination of the one or more of the N channels of audio data in each of the M channels of audio data has a predetermined phase relationship.

27. The method of claim 26 where processing one or more of the N channels of audio data with a fractional Hilbert function comprises:
performing a Hilbert transform on a left channel of audio data;
multiplying the Hilbert transformed left channel of audio data by a constant;
adding the scaled, Hilbert-transformed left channel of audio data to the left channel of audio data to generate a left channel of audio data having a predetermined phase shift; and
multiplying the phase-shifted left channel of audio data by a constant.

28. The method of claim 26 where processing one or more of the N channels of audio data with a fractional Hilbert function comprises:
performing a Hilbert transform on a right channel of audio data;
multiplying the Hilbert transformed right channel of audio data by a constant;
subtracting the scaled, Hilbert-transformed right channel of audio data from the right channel of audio data to generate a right channel of audio data having a predetermined phase shift; and
multiplying the phase-shifted right channel of audio data by a constant.

29. The method of claim 26 where processing one or more of the N channels of audio data with a fractional Hilbert function comprises:
performing a Hilbert transform on a left surround channel of audio data;
performing a Hilbert transform on a right surround channel of audio data;
multiplying the Hilbert transformed left surround channel of audio data by a constant; and
adding the scaled, Hilbert-transformed left surround channel of audio data to the Hilbert transformed right surround channel of audio data to generate a left-right channel of audio data having a predetermined phase shift.

30. The method of claim 26 where processing one or more of the N channels of audio data with a fractional Hilbert function comprises:
performing a Hilbert transform on a left surround channel of audio data;
performing a Hilbert transform on a right surround channel of audio data;
multiplying the Hilbert transformed right surround channel of audio data by a constant; and
adding the scaled, Hilbert-transformed right surround channel of audio data to the Hilbert transformed left surround channel of audio data to generate a right-left channel of audio data having a predetermined phase shift.

31. The method of claim 26 comprising:
performing a Hilbert transform on a left channel of audio data;
multiplying the Hilbert transformed left channel of audio data by a constant;
adding the scaled, Hilbert-transformed left channel of audio data to the left channel of audio data to generate a left channel of audio data having a predetermined phase shift;
multiplying the phase-shifted left channel of audio data by a constant;
performing a Hilbert transform on a right channel of audio data;
multiplying the Hilbert transformed right channel of audio data by a constant;
subtracting the scaled, Hilbert-transformed right channel of audio data from the right channel of audio data to generate a right channel of audio data having a predetermined phase shift;
multiplying the phase-shifted right channel of audio data by a constant;
performing a Hilbert transform on a left surround channel of audio data;
performing a Hilbert transform on a right surround channel of audio data;
multiplying the Hilbert transformed left surround channel of audio data by a constant;
adding the scaled, Hilbert-transformed left surround channel of audio data to the Hilbert transformed right surround channel of audio data to generate a left-right channel of audio data having a predetermined phase shift;
multiplying the Hilbert transformed right surround channel of audio data by a constant; and
adding the scaled, Hilbert-transformed right surround channel of audio data to the Hilbert transformed left surround channel of audio data to generate a right-left channel of audio data having a predetermined phase shift.

32. The method of claim 31 comprising:
summing the scaled left channel of audio data, the right-left channel of audio data and a scaled center channel of audio data to form a left watermarked channel of audio data; and
summing the scaled channel of audio data and the scaled center channel of audio data and subtracting from the sum the left-right channel of audio data and to form a right watermarked channel of audio data.

33. An audio spatial environment engine for converting from an N channel audio system to an M channel audio system, where N and M are integers and N is greater than M, comprising:
Hilbert transform means for receiving one of the N channels of audio data and applying a predetermined phase shift to the associated channel of audio data;
constant multiplier means for receiving one of the Hilbert transformed channels of audio data and generating a scaled Hilbert transformed channel of audio data;
summation means for receiving the one of the N channels of audio data and the scaled Hilbert transformed channel of audio data and each generating a fractional Hilbert channel of audio data; and
M second summation means for receiving one or more of the fractional Hilbert channels of audio data and one or more of the N channels of audio data, and for combining each of the one or more of the fractional Hilbert channels of audio data and the one or more of the N channels of audio data to generate one of M channels of audio data having a predetermined phase relationship between each the one or more of the fractional Hilbert channels of audio data and the one or more of the N channels of audio data.

34. The audio spatial environment engine of claim 33 comprising:
Hilbert transform means for processing a left channel of audio data;
multiplier means for multiplying the Hilbert transformed left channel of audio data by a constant;
summation means for adding the scaled, Hilbert transformed left channel of audio to the left channel of audio data to generate a left channel of audio data having a predetermined phase shift; and
multiplier means for multiplying the phase-shifted left channel of audio data by a constant, wherein the scaled, phase-shifted left channel of audio data is provided to one or more of the M second summation means.

35. The audio spatial environment engine of claim 33 comprising:
Hilbert transform means for processing a right channel of audio data;
multiplier means for multiplying the Hilbert transformed right channel of audio data by a constant;
summation means for adding the scaled, Hilbert transformed right channel of audio to the right channel of audio data to generate a right channel of audio data having a predetermined phase shift; and
multiplier means for multiplying the phase-shifted right channel of audio data by a constant, wherein the scaled, phase-shifted right channel of audio data is provided to one or more of the M second summation means.

36. The audio spatial environment engine of claim 33 comprising:
Hilbert transform means for processing a left surround channel of audio data;
Hilbert transform means for processing a right surround channel of audio data;
multiplier means for multiplying the Hilbert transformed left surround channel of audio data by a constant; and
summation means for adding the scaled, Hilbert transformed left surround channel of audio to the Hilbert transformed right surround channel of audio data to generate a left-right channel of audio data, wherein the left-right channel of audio data is provided to one or more of the M second summation means.

37. The audio spatial environment engine of claim 33 comprising:
Hilbert transform means for processing a left surround channel of audio data;
Hilbert transform means for processing a right surround channel of audio data;
multiplier means for multiplying the Hilbert transformed right surround channel of audio data by a constant; and
summation means for adding the scaled, Hilbert transformed right surround channel of audio to the Hilbert transformed left surround channel of audio data to generate a right-left channel of audio data, wherein the right-left channel of audio data is provided to one or more of the M second summation means.

38. An audio spatial environment engine for converting from an N channel audio system to an M channel audio system, where N and M are integers and N is greater than M, comprising:
a time domain to frequency domain conversion stage receiving the M channels of audio data and generating a plurality of sub-bands of audio spatial image data;
a filter generator receiving the M channels of the plurality of sub-bands of audio spatial image data and generating N′ channels of a plurality of sub-bands of audio spatial image data; and
a summation stage coupled to the filter generator and receiving the M channels of the plurality of sub-bands of audio spatial image data and the N′ channels of the plurality of sub-bands of audio spatial image data and generating scaled N′ channels of the plurality of sub-bands of audio spatial image data.

39. The audio spatial environment engine of claim 38 further comprising a frequency domain to time domain conversion stage receiving the scaled N′ channels of the plurality of sub-bands of audio spatial image data and generating the N′ channels of audio data.

40. The audio spatial environment engine of claim 38 further comprising:
a smoothing stage coupled to the filter generator, the smoothing stage receiving the N′ channels of the plurality of sub-bands of audio spatial image data and averaging each sub-band with one or more adjacent sub-bands; and
the summation stage coupled to the smoothing stage and receiving the M channels of the plurality of sub-bands of audio spatial image data and the smoothed N′ channels of the plurality of sub-bands of audio spatial image data and generating scaled N′ channels of the plurality of sub-bands of audio spatial image data.

41. The audio spatial environment engine of claim 38 wherein the summation stage further comprises a left channel summation stage multiplying each of a plurality of sub-bands of a left channel of the M channels times each of a corresponding plurality of sub-bands of audio spatial image data of a left channel of the N′ channels.

42. The audio spatial environment engine of claim 38 wherein the summation stage further comprises a right channel summation stage multiplying each of a plurality of sub-bands of a right channel of the M channels times each of a corresponding plurality of sub-bands of audio spatial image data of a right channel of the N′ channels.

43. The audio spatial environment engine of claim 38 wherein the summation stage further comprises a center channel summation stage satisfying for each sub-band an equation:
(G_{C}(f)*L(f)+((1−G_{C}(f))*R(f))*H_{C}(f)
where
G_{C}(f)=a center channel sub-band scaling factor;
L(f)=a left channel sub-band of the M channels;
R(f)=a right channel sub-band of the M channels; and
H_{C}(f)=a filtered center channel sub-band of the N′ channels.

44. The audio spatial environment engine of claim 38 wherein the summation stage further comprises a left surround channel summation stage satisfying for each sub-band an equation:
(G_{LS}(f)*L(f)−((1−G_{LS}(f))*R(f))*H_{LS}(f)
where
G_{LS}(f)=a left surround channel sub-band scaling factor;
L(f)=a left channel sub-band of the M channels;
R(f)=a right channel sub-band of the M channels; and
H_{LS}(f)=a filtered left surround channel sub-band of the N′ channels.

45. The audio spatial environment engine of claim 38 wherein the summation stage further comprises a right surround channel summation stage satisfying for each sub-band an equation:
((1−G_{RS}(f))*R(f))+(G_{RS}(f))*L(f))*H_{RS}(f)
where
G_{RS}(f)=a right surround channel sub-band scaling factor;
L(f)=a left channel sub-band of the M channels;
R(f)=a right channel sub-band of the M channels; and
H_{RS}(f)=a filtered right surround channel sub-band of the N′ channels.

48. A method for converting from an M channel audio system to an N channel audio system, where M and N are integers and N is greater than M, comprising:
receiving the M channels of audio data;
generating a plurality of sub-bands of audio spatial image data for each channel of the M channels;
filtering the M channels of the plurality of sub-bands of audio spatial image data to generate N′ channels of a plurality of sub-bands of audio spatial image data; and
multiplying the M channels of the plurality of sub-bands of audio spatial image data by the N′ channels of the plurality of sub-bands of audio spatial image data to generate scaled N′ channels of the plurality of sub-bands of audio spatial image data.

47. The method of claim 46 wherein multiplying the M channels of the plurality of sub-bands of audio spatial image data by the N′ channels of the plurality of sub-bands of audio spatial image data further comprises:
multiplying one or more of the M channels of the plurality of sub-bands of audio spatial image data by a sub-band scaling factor; and
multiplying the scaled M channels of the plurality of sub-bands of audio spatial image data by the N′ channels of the plurality of sub-bands of audio spatial image data.

48. The method of claim 46 wherein multiplying the M channels of the plurality of sub-bands of audio spatial image data by the N′ channels of the plurality of sub-bands of audio spatial image data further comprises multiplying each of the plurality of sub-bands of the M channels by a corresponding sub-band of audio spatial image data of the N′ channels.

49. The method of claim 46 wherein multiplying the M channels of the plurality of sub-bands of audio spatial image data by the N′ channels of the plurality of sub-bands of audio spatial image data comprises multiplying each of a plurality of sub-bands of a left channel of the M channels times each of a corresponding plurality of sub-bands of audio spatial image data of a left channel of the N′ channels.

50. The method of claim 46 wherein multiplying the M channels of the plurality of sub-bands of audio spatial image data by the N′ channels of the plurality of sub-bands of audio spatial image data comprises multiplying each of a plurality of sub-bands of a right channel of the M channels times each of a corresponding plurality of sub-bands of audio spatial image data of a right channel of the N′ channels.

51. The method of claim 46 wherein multiplying the M channels of the plurality of sub-bands of audio spatial image data by the N′ channels of the plurality of sub-bands of audio spatial image data comprises satisfying for each sub-band an equation:
(G_{C}(f)*L(f)+((1−G_{C}(f))*R(f))*H_{C}(f)
where
G_{C}(f)=a center channel sub-band scaling factor;
L(f)=a left channel sub-band;
R(f)=a right channel sub-band; and
H_{C}(f)=a filtered center channel sub-band.

52. The method of claim 46 wherein multiplying the M channels of the plurality of sub-bands of audio spatial image data by the N′ channels of the plurality of sub-bands of audio spatial image data comprises satisfying for each sub-band an equation:
(G_{LS}(f)*L(f)−((1−G_{LS}(f))*R(f))*H_{LS}(f)
where
G_{LS}(f)=a left surround channel sub-band scaling factor;
L(f)=a left channel sub-band;
R(f)=a right channel sub-band; and
H_{LS}(f)=a filtered left surround channel sub-band.

53. The method of claim 46 wherein multiplying the M channels of the plurality of sub-bands of audio spatial image data by the N′ channels of the plurality of sub-bands of audio spatial image data comprises satisfying for each sub-band an equation:
((1−G_{RS}(f))*R(f))+(G_{RS}(f))*L(f))*H_{RS}(f)
where
G_{RS}(f)=a right surround channel sub-band scaling factor;
L(f)=a left channel sub-band;
R(f)=a right channel sub-band; and
H_{RS}(f)=a filtered right surround channel sub-band.

54. An audio spatial environment engine for converting from an M channel audio system to an N channel audio system, where M and N are integers and N is greater than M, comprising:
time domain to frequency domain conversion means for receiving the M channels of audio data and generating a plurality of sub-bands of audio spatial image data;
filter generator means for receiving the M channels of the plurality of sub-bands of audio spatial image data and generating N′ channels of a plurality of sub-bands of audio spatial image data; and
summation stage means for receiving the M channels of the plurality of sub-bands of audio spatial image data and the N′ channels of the plurality of sub-bands of audio spatial image data and generating scaled N′ channels of the plurality of sub-bands of audio spatial image data.

55. The audio spatial environment engine of claim 54 further comprising frequency domain to time domain conversion stage means for receiving the scaled N′ channels of the plurality of sub-bands of audio spatial image data and generating the N′ channels of audio data.

56. The audio spatial environment engine of claim 54 further comprising:
smoothing stage means for receiving the N′ channels of the plurality of sub-bands of audio spatial image data and averaging each sub-band with one or more adjacent sub-bands; and
wherein the summation stage means receives the M channels of the plurality of sub-bands of audio spatial image data and the smoothed N′ channels of the plurality of sub-bands of audio spatial image data and generates scaled N′ channels of the plurality of sub-bands of audio spatial image data.

57. The audio spatial environment engine of claim 54 wherein the summation stage means further comprises left channel summation stage means for multiplying each of a plurality of sub-bands of a left channel of the M channels times each of a corresponding plurality of sub-bands of audio spatial image data of a left channel of the N′ channels.
